(19) United States
(12) Patent Application Publication
(10) Pub. No.: US 2018/0008855 A1
(43) Pub. Date: Jan. 11, 2018

(54) VEHICLE EXERCISE SYSTEM

(71) Applicant: ActivBody, Inc., Aliso Viejo, CA (US)

(72) Inventors: Kostadin Dimitrov Yanev, Monte-Carlo (MC); Angel Georgiev Vassilev, Aliso Viejo, CA (US)

(21) Appl. No.: 15/657,913

(22) Filed: Jul. 24, 2017

Related U.S. Application Data
(63) Continuation-in-part of application No. 15/521,167.

(51) Int. Cl. A63B 21/002; A63B 24/00; A63B 71/06; B60N 2/00; B60R 99/00; G09B 19/00; B60N 99/00

(52) U.S. Cl. CPC A63B 21/0023; G09B 19/0038; A63B 24/0062; B60N 99/00; B60N 2/002; B60R 99/00; A63B 24/0075; A63B 24/0087; A63B 71/0622; A63B 2220/51; A63B 2220/17; A63B 2208/0233; A63B 2071/0655; A63B 2071/063; A63B 2230/75; A63B 2071/0625; A63B 2024/0096; A63B 2220/56; A63B 2220/62; A63B 2225/50; A63B 2071/0627

(57) ABSTRACT

The present invention relates to systems, methods, and apparatus that facilitate exercise in vehicles. In particular, the present invention provides active exercise in passenger and navigation areas in vehicles by incorporating force sensors in the environment surrounding the passenger and/or navigator in the vehicle. The present invention applies the principles of isometric training and interacts with a remote or on-board computer platform to track, measure and provide instruction to the passage and/or navigator engaged in such isometric training.

### RELATED ART

This application is a continuation-in-part of U.S. patent application Ser. No. 15/521,167, filed on Apr. 21, 2017, titled EXERCISE SYSTEMS, METHODS, AND APPARATUSES CONFIGURED FOR EVALUATING MUSCULAR ACTIVITY OF USERS DURING PHYSICAL EXERCISE AND/OR PROVIDING FEEDBACK, which is a 371 application of US PCT Application No. PCT/US2015/068143, filed on Dec. 30, 2015, titled EXERCISE SYSTEMS, METHODS, AND APPARATUSES CONFIGURED FOR EVALUATING MUSCULAR ACTIVITY OF USERS DURING PHYSICAL EXERCISE AND/OR PROVIDING FEEDBACK, which claims priority to U.S. patent application Ser. No. 14/588,257, filed on Dec. 31, 2014, titled EXERCISE SYSTEMS, METHODS, AND APPARATUSES CONFIGURED FOR EVALUATING MUSCULAR ACTIVITY OF USERS DURING PHYSICAL EXERCISE AND/OR PROVIDING FEEDBACK, all applications of which are incorporated into this application in its entirety.

### FIELD OF THE INVENTION

The present invention relates to the integration of exercise apparatus having force sensors into a seating area to allow the person to engage in isometric exercise activity while in a seated position for long periods of time.

### BACKGROUND

Passenger and navigation areas in vehicles, such as automobiles, airplanes, boats, buses, trains and even space craft, while limited in volume, are the space where humans spend considerable amounts of time in a static or sedentary condition, such as in seats, berths, recliners, etc. Being inactive for long periods of time has been proven quite unhealthy. A need therefore exists to find a way to incorporate exercise into environments generally known to only engage individuals in only static or sedentary conditions. By incorporating exercise into such environments, individuals that find themselves in seated, resting or inactive conditions for long periods of time will be offered a way to improve their lifestyle.

### SUMMARY

Modern vehicles employ technology that provides an opportunity to add exercising in passenger and navigation areas in vehicles. In particular, force sensors can be placed in the environment surrounding the passenger and/or navigator in the vehicle to facilitate active exercising in static seating areas, by applying the principles of isometric training.

Being static by definition, a wide range of isometric exercises (isometrics) can be performed in any human accommodating vehicle interior, training all main muscle groups into a full body workout, without challenging the established safety and comfort standards. Isometrics efficiency in fitness terms, especially if used in multiple short bursts over longer time periods, is proven to outperform gym fitness, and their health effect, especially in sitting context, can be safely qualified as “the opposite of passive movement.” Thus, isometrics are particularly feasible to perform during a vehicle ride, in multiple sessions, that could be as short as several seconds, with shorter or longer in-between breaks.

The present invention relates to systems, methods, and apparatus that facilitate exercise in vehicles. In particular, the present invention provides active exercise in passenger and navigation areas in vehicles by incorporating exercise apparatus having force sensors in the environment surrounding the passenger and/or navigator in the vehicle. The present invention applies the principles of isometric training and interacts with a remote or on-board computer platform to track, measure and provide instruction to the passenger and/or navigator engaged in such isometric training.

The exercise apparatuses may be located to engage one or more body parts of the user. The user may perform isometric exercises by exerting forces on individual ones of the one or more of the sensor integrated into the seating area.

Through the incorporation of sensors in the environment surrounding the passenger and/or navigator, isometrics become accessible not only to passengers but also to navigators as well. For safety reason, depending upon the application, it may be desirable to only allow navigators to be able to execute short exercising sessions on multiple occasions when the vehicle is not moving or does not compromise safety—like waiting at traffic lights, in stuck traffic, etc. The cumulative duration of such exercising by a commuting driver in city traffic may be substantial, equaling the effect of a gym session on daily basis. Isometrics' universal feasibility in vehicles will be further increasing with the spread of autonomous cars, where even single passengers will be free to exercise anytime in the vehicle.

In some implementations, gameplay may be incorporated into one or more exercises through interaction with a gaming application. Users may be coached during gameplay to perform one or more exercises such that exercise and gameplay may be seamlessly integrated.

One or more aspects of the disclosure relate to a system for monitoring and recording muscular activity of a passenger or navigator (i.e., user) during exercise and/or providing feedback to the user. The system may include one or more exercise apparatuses configured to engage a user in a substantially seated position in isometric exercises.

For example, exercise apparatus may be incorporated into the seating area surrounding the user, including, but not limited to the seat, dash, arm rests, door handles, the steering wheel, foot supports, the console, the ceilings, ceiling handles, safety belts and gear shifts. The exercise apparatus may comprise one or more physical user interface components configured to engage one or more body parts of the user while in the substantially seated position. The user may perform exercises by exerting forces on individual ones of the one or more user interface components. In some implementations, the exercise apparatus may include one or more repositionable apparatus and/or mobile apparatus. A user may perform exercise using the apparatus by exerting forces on individual ones of the repositionable apparatus, mobile apparatus, and/or fixed apparatus, or any combination thereof.

Each exercise apparatus may include one or more sensors configured to generate output signals. The output signal may convey information related to one or more parameters of muscular activity of the user during the exercises and/or other information. The parameters may correspond to one or more of a muscle and/or muscle group activated by the user during performance of a given exercise, an amount of force exerted by the muscle and/or muscle group during a given exercise, an amount of repetitions of activation of the muscle and/or muscle group, an elapsed time of performance of a given exercise, an amount of energy expended (e.g., calories burned), and/or other parameter of muscular activity. Individual ones of the one or more sensors may be coupled to corresponding individual ones of the one or more user interface components and/or sensor configurations.

In some implementations, output signals of a sensor may convey information that may be used to determine and/or express a quantification of exertion by a user. The quantification of exertion may include a quantification of one or more measures. Examples of such measures may include one or more of force, pressure, energy, power, duration, displacement, acceleration, and/or other measure useful in quantifying exertion. Force may be expressed in units of Newtons, pounds (force), Dyne, Ton-force, kilogram-force, Kip, and/or other units of force. Force may be expressed in units of Pascals, pounds per square inch (PSI), Bar, Torr, atmosphere, and/or other units of pressure or force. Energy may be expressed in units of calories, joules, horsepower-hour, foot-pound force, body fat equivalent, and/or other units of energy. Body fat equivalent (“BFE”) may be an energy measure that shows the user how much energy was expended in terms of body fat (e.g., how much body fat was burned during a given exercise or exercise session). Power may be expressed in units of watts, horsepower, and/or other units of power. The quantification of exertion may provide continuous and/or discrete values of measures related to the application of force by a user during exercise. The values of measures may be expressed as a function of time. By way of non-limiting example, a sensor may generate output signals conveying an amount of force exerted by the user at or near the sensor. To illustrate, a user may press their hand at or near a sensor and that sensor may generate output signals conveying information related to an amount of force exerted by the user's hand. By way of non-limiting example, a sensor may generate output signals conveying discrete predetermined force levels based on an amount of force exerted by the user meeting or exceeding the predetermined force levels. To illustrate, a user may press their hand at or near a sensor using a first level of force for some duration and using a second level of force for a later duration, the first level of force being less than the second level of force.

The one or more sensors may be configured to communicatively couple with one or more physical processors. The one or more processors may be disposed at an exercise apparatus, a computing platform (including but not limited to an on-board vehicle computing platform or infotainment system), a remote server, and/or other locations in the system.

The system may include one or more feedback components. A feedback component may include one or more components configured to provide one or more of visual feedback, auditory feedback, tactile feedback, olfactory feedback, and/or other feedback. A feedback component may be disposed at an exercise apparatus, a computing platform, and/or other location.

The one or more processors may be configured to execute one or more computer program components. The computer program components may include computer-readable instructions stored on storage media. The computer program components may include one or more of a communication component, a space component, a user component, a coach component, an interface component, and/or other computer program components.

The communication component may be configured to facilitate information communication between computer program components and/or the processor(s), between one or more computer program components and an entity external to the processor(s) (e.g., a feedback component, a sensor, and/or other entity), and/or may facilitate other information exchanges. In some implementations, the communication component may be configured to obtain output signals associated with the one or more sensors.

The space component may be configured to execute an instance of a game and implement the instance of the game to facilitate user participation in the game that takes place in a virtual space. User participation in the game may include controlling game entities within the virtual space. The space component may also provide for exercise in a virtual space, through participation of muscle movement activities to control movement through the virtual space.

The user component may be configured to access and/or manage user profiles associated with the users of the system. The user component may be configured to determine values for the one or more parameters of muscular activity for the users based on the output signals (e.g., obtained by the communication component). The user component may be configured to provide the determined values as control inputs for controlling the game entities in the virtual space (e.g., via the space component).

The coach component may be configured to effectuate presentation of exercise instruction to a user via one or more feedback components. The instruction may be related to coaching a user to perform one or more exercises and/or to coaching the user on the way to perform the particular chosen exercises before or during the execution. For example, the instruction may be related to coaching a user on exerting forces on the exercise apparatus using one or more muscles and/or muscle groups. The coach component may be configured to modify the presented exercise instruction based on the values of the parameters of muscular activity determined by the user component. The modification may include changing the instruction based on a user's accuracy in following instruction, repeating instruction and/or changing one or more aspects of the instruction to encourage a user to successfully perform an exercise, and/or other modification. For example, the modification may correspond to coaching a user to continue exerting forces using a given muscle and/or muscle group or to exert forces using a different muscle and/or muscle group.

The interface component may be configured to effectuate presentation of an interface via a feedback component (e.g., a display and/or screen). The interface may include views of a virtual space and/or game executed by the space component and/or other information.

One or more aspects of the disclosure relate to systems and methods for coaching a user to perform one or more exercises. Coaching a user may comprise operations including: effectuating presentation of exercise instruction via one or more feedback components; obtaining output signals from one or more sensors coupled to an exercise apparatus; determining values for the one or more parameters of muscular activity based on the output signals; modifying the presented exercise instruction based on the determined values; and/or other operations.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is intended that all such additional systems, methods, features and advantages be included within this description, be within the scope of the invention, and be protected by the accompanying claims. It is to be expressly understood, however, that the drawings are for the purpose of illustration and description only and are not intended as a definition of the limits of the invention. As used in the specification and in the claims, the singular forms of “a”, “an”, and “the” include plural referents unless the context clearly dictates otherwise.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates one example of an exercise apparatus of the invention.

FIG. 2a illustrates one example of a seating area of a vehicle having exercise apparatus integrated therein.

FIG. 2b illustrates one example of the back of the seat having a user interface for interfacing with the user and the exercise apparatus integrated into the surrounding passenger area.

FIG. 3 illustrates one example of a seat having exercise apparatus integrated into the seat at various positions.

FIG. 4 illustrates a system configured for evaluating muscular activity of a user during exercise and/or providing feedback to the user in accordance with one or more implementations of the present invention.

FIG. 5 illustrates one or more processors in accordance with one or more implementations of the present invention.

FIG. 6 illustrates an exemplary implementation of a user interface for engaging the user in exercise.

FIG. 7 illustrates another exemplary implementation of a user interface for engaging the user in exercise.

FIG. 8 illustrates a method of coaching a user performing one or more exercises, in accordance with one or more implementations of the present invention.

FIG. 9 illustrates a method of evaluating muscular activity of a user during exercise and/or providing feedback to the user, in accordance with one or more implementations of the present invention.

FIG. 10 illustrates a method of using an exercise apparatus, in accordance with one or more implementations of the present invention.

### DETAILED DESCRIPTION OF THE INVENTION

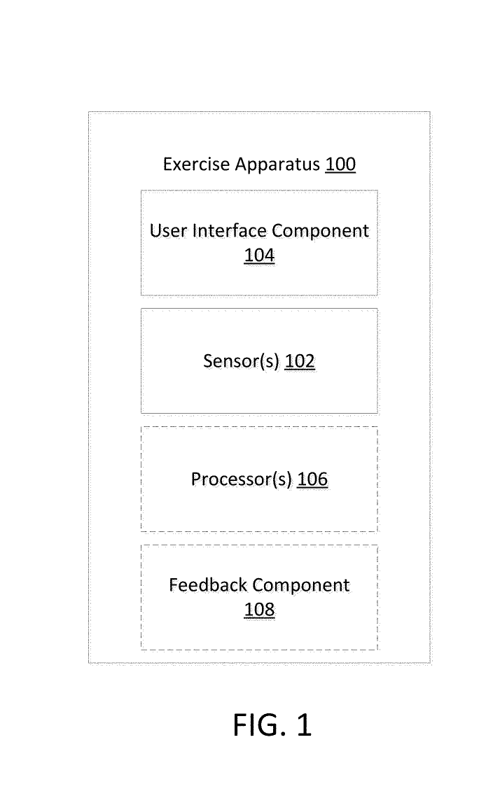

As illustrated in FIGS. 1-10, a system, method and various apparatus are provided for enabling movement and exercise in the passenger and/or navigation areas of vehicles (i.e. the “seating area”). For purposes of this application, a “vehicle” shall mean any moving machinery for carrying or transporting something. Vehicles shall include, but not be limited to, automobiles, buses, boats, planes, trains, shuttles (including space shuttles), or any other moving transportation device that includes an area designed to transport one or more humans. “Passengers” are defined as humans in the vehicle who are not engaged in the vehicle's real-time operation, and thus, passengers may include crew and/or staff. “Navigators” shall be defined as the human or humans responsible for navigating and/or driving the vehicle.

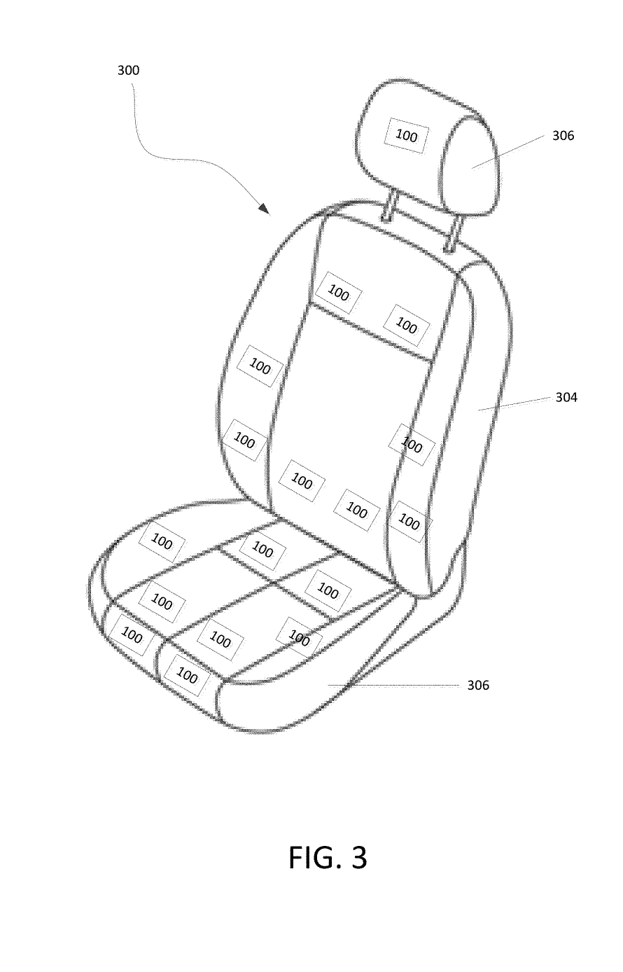

FIG. 1 illustrates one example of an exercise apparatus 100 of the invention. The exercise apparatus 100 may include a user interface component 104, one or more sensors 102, and optionally, a processor 106 and/or other components, including, but not limited to a feedback component (as explained further below in connection with FIG. 4). The sensors 102 may be disposed near and/or directly under the user interface component 104. Individual ones of one or more sensors 102 may be coupled to corresponding ones of the one or more user interface components 104. The sensor(s) 102 may be configured to communicatively couple to one or more processor 106 located within the exercise apparatus 100 and/or remote to the exercise apparatus 100 (as explained further below).

The exercise apparatus 100 may be configured for wired and/or wireless communication. By way of non-limiting example, the exercise apparatus 100 may be configured for wired communication via hard wiring directly to the apparatus or via a port or a drive disposed at a given exercise apparatus 100. A port disposed at the exercise apparatus 100 may include a USB port, a firewire port, and/or other port. By way of non-limiting examples, the exercise apparatus 100 may be configured for wireless communication via Bluetooth, near-field communication, infrared, Wi-Fi, and/or other wireless communication protocol.

In some implementations, a given sensor 102 may comprise a sensor configured to measure one or more of force, torque, strain, displacement, position, compression, temperature, pressure, contact, and/or other measurement. For example, a sensor 102 may comprise one or more of a strain measurement sensor, a force-sensing resistor, a force-sensitive material, a load sensor, a pressure or force sensor, a load cell, a touch sensor, a position sensor, a temperature sensor, displacement sensor, tension sensitive materials and/or other sensor. As used in this application, when referenced that a force sensor measures “force” it is meant that the sensor may measure one or more of force, torque, strain, displacement, pressure and/or contact.

In some implementations, the sensor(s) 102 may comprise one or more sensors that generate output signals used to determine values for the parameters directly or indirectly. For example, a first sensor may generate a first output signal(s) used to determine, directly or indirectly, a first value of a first parameter. In some implementations, a sensor may be configured to generate output signals directly related to force applied at or near the sensor, and/or other output.

By way of non-limiting example, a given force-measuring sensor may be disposed at a location on a corresponding user interface component 104 configured to be pushed by a hand of a user. The force measurement sensor may generate output signals directly related to a force applied to the user interface component 104. The output signals may directly provide a value of a force parameter associated with the user, and/or other parameter. By way of non-limiting example, a touch sensor may generate sensor output related to instances of contact with the sensor and/or user interface component 104 at or near the sensor. Sensor output from the touch sensor may include a count of an amount of times the sensor is “touched” or otherwise activated. The sensor output may directly provide a value of a repetition parameter associated with repetitive activation of a muscle and/or muscle group. In some implementations, other sensors may be configured to generate other output signals that are directly related to values of other parameters corresponding to muscular activity.

In some implementations, a sensor 102 may be configured to generate output signals that may be indirectly related to a value of a parameter. By way of non-limiting example, a position sensor may be configured to generate output signals related to an amount of displacement or deflection of a corresponding user interface component 104. Output signals from a position sensor (e.g., corresponding to an amount of deflection) may be used to determine (e.g., calculate) an amount of force imparted on the user interface component 104 by the user. The determination may be based on an arrangement, configuration, material properties, and/or other attribute of the user interface component 104.

By way of a non-limiting example, a user interface component 104 may be approximated as a cantilever beam. A determination may be based on calculating an amount of force required to deflect the approximated cantilever beam a measured deflected distance (e.g., based on the output signal). The sensor output may indirectly provide a value of a force parameter, and/or other parameter. By way of non-limiting example, one or more sensors 102 may be configured to generate output signals related to an amount of compression of a user interface component 104, torsion on a user interface component 104, strain on a user interface component 104, and/or other measurement that may be used to determine a parameter value indirectly.

The device relies upon a force sensing technology, which may be force sensing resistors, load cells using strain gauges, displacement sensors (such as linear variable differential transformer (LVDT) devices, Hall Effect sensors and optical sensors), piezoresistive sensors and pressure sensors. In one example, the load cells consist of a half-bridge strain gauge mounted on cantilever beams.

With respect to the incorporation of the load cells, there are a variety of possible geometries used for load cells (“W” shape, “J” shape, “U” shape and “S” shapes). The “I” geometry (a simple bending beam) is the lowest cost and smallest, but it is less frequently used because the geometry provides a single polarity of strain and because of challenges in supporting the cantilever beam.

In one example of an implementation, the exercise apparatus 100 may incorporate a cantilever load cell (such as a simple “I” shaped cantilever load cell) with an attached strain gauge that changes resistance proportionally to deflection of the tip of the cantilever as force is applied. The device may further include multiple anchor points securing the cantilever to the frame for more accurate measurements even at higher force levels and to realize a consistent inflection point. The multiple load cells may be spaced toward the periphery of the interface component 104, providing a large active area where force can be applied by the user with accurate force sensing. The load cells may further be designed so that the load point of the cell is a close as possible to the tip of the cantilever beam providing a large active area.

Application of force causes a transfer of force to high strength steel load cells inside the device. Each of the load cells contains integrated strain gages that convert strain into a small change in resistance. With the application of a wheat stone half-bridge the circuit outputs a measurable change in voltage with temperature compensation. Half-bridge strain gauges may include at least one active piezoresistive element to sense elongation of the cantilever and at least one other identical active piezoresistive element acting as a reference for temperature compensation to ensure accurate force measurements across the temperature range.

This voltage from each strain gauge is amplified and then measured by an analog to digital converter (ADC). Firmware in the exercise apparatus 100 may load linear calibration and tare data from non-volatile memory to convert voltages read from each load cell into force. The force values are all summed to determine the total force experienced by the device. While in use, force measurements may be taken at predetermine intervals, for example, every 100 ms. Results may then be communicated to a computer platform or other storage or processing device for use.

While the above describes the possible implementation of sensor 102 as load cells consist of a half-bridge strain gauge mounted on cantilever beams, it is recognized that this type of force sensor may not be the most desirable to use in all areas of a vehicle passenger compartment. Other sensors may work better depending upon the desired location of the sensor, the applied forces and materials used in the construction of that particular area or component of the passenger compartment.

As will be explained and described further below, the exercise apparatus 100 can be used in connection with a variety of compressive activities developed around isometric training to exercise major muscle groups. The exercise apparatus 100 can interact with application software, such as fitness and game software to enhance the exercise experience. When interacting with applications, the applications require the user to apply pressure or force to the exercise apparatus 100 at varying intensities and durations.

The exercise apparatus 100 may be designed to withstand pressures in excess of 200 pounds, and provide mechanical displacement proportional to the force applied—all while maintaining the accuracy requirement. Some sensor technologies 102 may require the addition of temperature compensation and some level of noise filtering, calibration adjustments and possibly provide corrections to compensate for measurement accuracy limitations, non-linearity, weight applied by the user unrelated to exercise activities and weight applied as a results of vehicle movement.

The above description of determining values for one or more parameters of muscular activity either directly or indirectly are not intended to be limiting. Instead, this is provided for illustrative purposes only and is not intended to be limiting with respect to the sensors 102, configurations and/or arrangement of the user interface components 104, and/or the manner or techniques in which values may be determined.

As explained further below, the exercise apparatus 100 can operate in conjunction with a remote application running on a personal mobile device or computer, such as phone, tablet or other personal computing device and/or with an on-board vehicle computing system (i.e., infotainment system). The exercise apparatus 100 communicate with the application, which together operates as a system. The exercise apparatus 100 may be capable of converting, in real-time, the repeated forces applied to the apparatus 100 into digital measurements and then communicating with the computing platform in real-time to provide the user with information about the force the user is applying to the one or more exercise apparatus 100. In other instances, an analog-to-digital converter may be part of a centralized specially dedicated or generic onboard computer so that the apparatus 100 may only output raw analog signal to the computing platform. The system can allow users to interact with various applications (e.g., fitness, gaming applications) by applying force to the interface component 101 of the exercise apparatus 100.

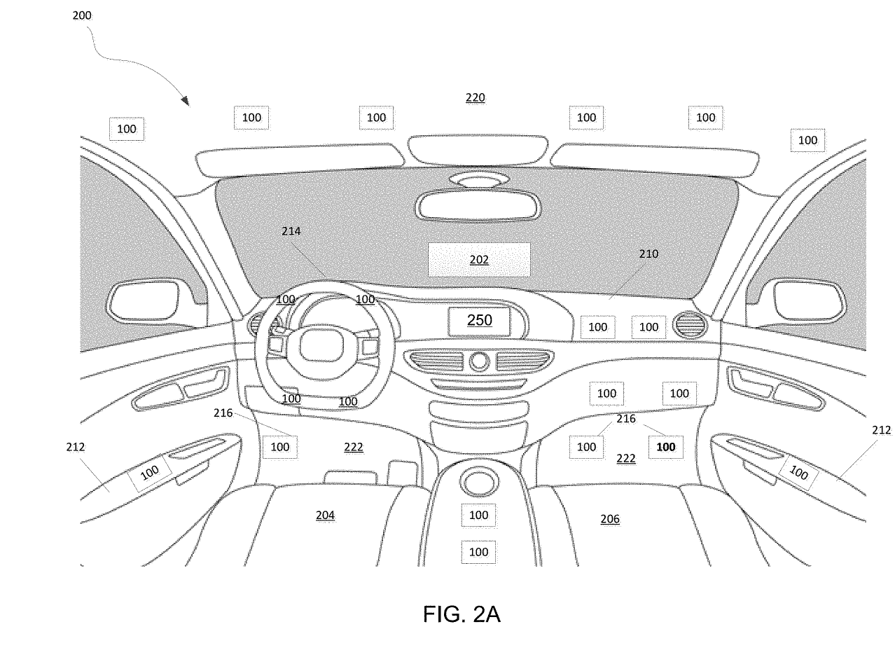

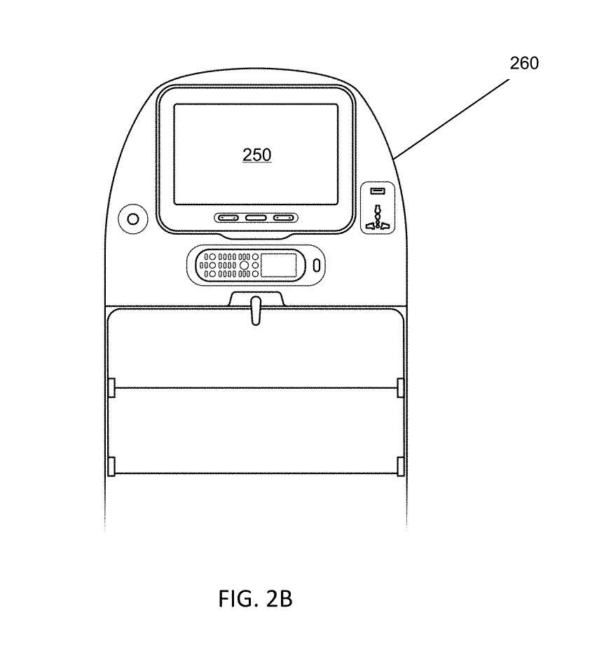

FIG. 2 illustrates one example of a seating area 202 of a vehicle 200 in which exercise apparatus 100 may be incorporated to allow for both passengers and navigators to engage in isometric exercises. FIG. 2b illustrates one example of the back of the seat having a user interface for interfacing with the user and the exercise apparatus integrated into the surrounding passenger area. FIG. 3 illustrates exercise apparatus 100 positioned within a seat 300 of the type that may be used in a vehicle like vehicle 200 (FIG. 2) and including, but to limited to, cars, airplanes, boats and other passenger vehicles.

In the illustrated example, the seating area 202 is the cockpit area of a car 200, and includes both a passenger seating area 206 and navigator seating area 204. As illustrated in FIG. 2, exercise apparatus 100 may be placed at various locations around the seating areas 202, including in the dash 210, in arm rests/door handles 212, in the steering wheel 214, in foot supports 216, floor 222, in the console 218, in the ceilings 220 and ceiling handles (not shown), in safety belts (not shown) and in gear shifts (also not shown).

As illustrated in FIG. 3, exercise apparatus 100 may also be integrated into the seats 300 at various positions. For example, exercise apparatus 100 may be located in seat bottoms 202, seat backs 204 and head rests 206, as well as arm rest (not shown) when the arm rests form part of the seat 200. Exercise apparatus 100 may be integrated discreetly in different parts of the vehicle seating area 202. Other such sensors 104 may be integrated as parts of specially installed interior elements (for example, additional arm rests or foot supports). Yet, other such sensors 104 may be integrated in portable, mobile, wearable and/or other type of devices that are not fixed and/or physically integrated to the vehicle seating area and/or any of its parts.

The components of the vehicle seating area 100 in which the force sensors 102 are installed may form part of the user interface components 104 designed to receive forces exerted by a user during performance of one or more exercises. It will be recognized that more than one sensor 102 may be used at any given location to measure such forced exerted by a user. In this regard, individual sensors or more than one sensor 102 may be coupled to, or integrated with, one or more user interface components 104 at one or more locations under such interface component 104.

The interface component 104 may comprise the interior to the car itself (i.e., the dash 210, console 218 or arm rest/door handle 212) with sensors placed directly thereunder. Alternatively, the sensors 102 may be covered by, or contained within a plastic shell that forms the interface component 104 together with the interior of the car under which the interface component 104 may be positioned.

In one example, the interface component 104 may designed to be deformable (e.g., being made from thin, flexible material) or may be designed to be moveable relative to the sensors, whereby the interface component 104 is a hard plastic. For example, when incorporated into the dash or console of the vehicle, such as the dash 210 and console 218 in vehicle 200 (FIG. 2), the sensors 102 may be positioned directly under such vehicle interior surface. In this case, the interface components 104 may be a hard plastic or deformable plastic that forms part of the interior of the vehicle.

Alternatively, the sensors 102 may be housed in a shell positioned under the vehicle interior 104. The shell may form a cover over the sensors 102. The shell may be constructed of materials, such as engineering plastics, that have the ability to withstand the user applied force, to withstand the cyclical loading characteristic of isometric exercise, provide a water/sweat resistant barrier for the electronic components, withstand standard cleaning agents and chemicals, and are sufficiently sealed so that ingress does not compromise the internal components. An elastomer that is co-molded with hard plastic parts may also be provided for limited shell motion, should it be required. The shell may also be constructed of designed from a sheet, net, web, tarp, cover, coverlet, and/or other thin, flexible material, or from fabric, cloth, plastic, leather, and/or other material.

In another example, when positioned within a seat 300, it may be desirable to position the exercise apparatus having a shell under the upholstery of the seat 300. By way of example, a sensor configuration positioned within a seat 300 may comprise a sensor bar or pad formed from fabric, foam, and/or other material that comprises and/or houses one or more sensors 102 positioned under the seat 300. In this example, the interface component 104 may be a combination of elements, including the seat upholstery and shell covering the sensors 102. For example, the upholstery can be both the force sensor and the interface component 104 in one.

Although the exercise apparatus 100 is shown having a substantially rectangular shape, this for illustrative purposes only and should not be considered limiting. For example, in other implementations, the shape of the exercise apparatus 100 may be circular, oval, square, body shaped, and/or other shape.

The interface components 104 are configured to engage one or more body parts of a user. In some examples, the user interface components 104 may comprise repositionable sensor configurations including one or more sensors 102. In this manner, one or more user interface components 104 may be movable/repositionable relative to the sensors 102, or may be remain stationary.

In some implementations, one or more user interface components 104 may be removably engageable to the exercise apparatus 100. Removable engagement of a user interface component 104 to the exercise apparatus 100 may be accomplished by one or more removable fasteners connecting the user interface components 104 to the exercise apparatus 100. A removable fastener may comprise hook and loop fabric, snap fits, and/or other removable fastener.

In another example of an aftermarket implementation, the exercise apparatus 100 may incorporated into a flexible material that facilitates covering (e.g., placing over, draping over, and/or other type of covering) a structure with the exercise apparatus 100, such as a back rest, head rest, floor mats, seat cushion, etc. For example, the exercise apparatus 100 may be configured to cover one or more parts of a vehicle, including but not limited to the seat 306, seat back 304, headrest 306, floor 220, dash 210, console 218, arm rest/door rest 212, bench, seat belt, glove compartment, or other component or structure found in a vehicle seating area. The user may then be able to perform one or more exercises while the exercise apparatus 100 form part of a structure cover. Alternatively, rather than a covering, exercise apparatus 100 can be incorporated into straps or other devices that removable attached to various structure of a vehicle.

Regardless of whether the exercise apparatus 100 are integrated directly into the seating area or are integrated in covers, mobile or repositionable exercise apparatus 100, the user interface component(s) 104 may be configured and/or arranged at positions to enable the engagement of one or more body parts of the user and/or be positioned/repositioned in an arrangement compatible with a user imparting forces thereon during exercise. In some implementations, the one or more user interface component(s) 104 may include components configured and/or arranged to engage one or more of a finger, a hand, a wrist, an elbow, an arm, a torso, a head, a shoulder, a hip, a thigh, a knee, a calf, an ankle, a foot, and/or any other body part of the user. By way of non-limiting examples, a user may impart a force onto one or more user interface components 104 by pressing, pulling, pushing, squeezing, lifting, striking, shaking, twisting, turning, separating, and/or otherwise imparting a force onto one or more of the user interface components 104 or portions thereof. By way of an additional non-limiting example, a user may impart a force onto a user interface component 104 configured to engage a hand of a user by squeezing the user interface component 104 (e.g., the user interface component 104 may be hand grip).

It is noted that the above example of various arrangements of sensors 106 and/or user interface components 104 is not to be considered limiting. Instead, it is merely provided as an illustrative example and should not limit the manner in which one or more sensors 102 may be coupled to one or more user interface components 104.

By way of non-limiting examples, a given exercise apparatus 100 may be configured and/or arranged to engage an arm of a user; a given exercise apparatus 100 may be configured and/or arranged to engage a hand (and/or one or more fingers and/or wrist) of a user; a given exercise apparatus 100 may be configured and/or arranged to engage the back of a user; a given exercise apparatus 100 may be configured and/or arranged to engage a shoulder of a user; a given exercise apparatus 100 may be configured and/or arranged to engage a head (and/or neck) of a user; a given exercise apparatus 100 may be configured and/or arranged to engage a thigh of a user; a given exercise apparatus 100 may be configured and/or arranged to engage a knee of a user; a given exercise apparatus 100 may be configured and/or arranged to engage a leg of a user; a given exercise apparatus 100 may be configured and/or arranged to engage a foot of a user; a given exercise apparatus 100 may be configured and/or arranged to engage an ankle of a user; and/or one or more other exercise apparatus 100 may be configured to engaged any other body of a user.

In some implementations, a user interface component 104 configured to engage a hand (and/or wrist and/or one or more fingers) may comprise a hand grip. The grip may be coupled to a sensor(s) 102. The sensor(s) 102 at the hand grip may be configured to generate output signals conveying information related to an amount of squeezing force exerted by a hand of a user. A user interface component 104 configured to engage an arm of a user may comprise an arm rest 212. The arm rest 212 may be coupled to one or more sensors 102. A sensor(s) 102 coupled to the arm rest 212 may comprise a sensor 102 configured to measure force. The sensor 102 may be disposed at or near a portion of the arm rest where a user's elbow may lay such that the sensor(s) 102 may generate output signals related to forces exerted via an elbow of the user. A sensor(s) 102 coupled to the arm rest 212 may comprise a sensor configured to measure displacement and may be disposed at a distal end of the arm rest.

In some implementations, the seat back 304 or back support may be a user interface component 104 for various exercise apparatus 100. The seat back 304 may be coupled to one or more sensors 102. For example, one or more sensors 102 configured to measure force may be disposed at one or more locations on the seat back 304 that may, for example, be positioned to align with a user's shoulders, shoulder blades, hips, elbows and/or hands. A user interface component 104 configured to engage a head of a user may comprise a headrest 306. As shown, a head rest 306 may be coupled to the seat back 304. The head rest 306 may be coupled to one or more sensors 102 configured to measure force exerted by the head or neck muscles of a user. A user interface component configured to engage a thigh/knee of a user (not shown) may also be incorporated into the seat 300. The thigh/knee portion may include at least one surface configured to engage a thigh and/or knee of a user while in a substantially seated position. The thigh/knee portion may extend from a distal end of an arm rest, and/or may be configured in other ways, such as a pivotal member connected from below or on the side of the seat bottom 306. The thigh/knee portion may be coupled to one or more sensors configured to measure force exerted by a user via their thigh and/or knee. A user interface component 104 configured to engage a foot of a user may include a foot rest 216. The foot rest 216 may include at least one surface configured to engage a foot and/or ankle of a user while in a substantially seated position. The foot rest 216 may be coupled to one or more sensors 102 configured to measure force exerted by a user via their foot and/or ankle.

Depending upon the positioning of the exercise apparatus 100 in the seating area of the vehicle and the body part of the user that the exercise apparatus 100 is designed to be engaged with, the sensors 102 of the exercise apparatus 100 may need to be calibrated differently. Calibration can occur in the factory, upon installation or upon use by a particular user.

Exercise apparatus 100 are configured around the seating area 202 to engage a user in a substantially seated position. The exercise apparatus 100 may be powered using the vehicles battery, vehicle electronic system, a battery pack, an electrical cord for connection with a conventional power outlet, a power generating apparatus, cigarette lighter, USB and/or other components general used to power electrical components in a vehicle. A power generating apparatus may comprise, for example, a piezoelectric power generating apparatus. In some implementations, at least a portion of the exercise apparatus 100 may comprise piezoelectric power generating material. For example, piezoelectric power-generating material may be incorporated into the seat to generate power each time a user sits and/or moves upon the seat. When not directly connected to the vehicle battery or the vehicle electrical system for power, the exercise apparatus 100, as described above, may be self powered, or optionally powered by plugging into the vehicle's standard powering outlets (e.g. USB/lighter, etc.).

The exercise apparatus may also interface with an on-board computer system having a user interface 250 in the vehicle, which may be the user interface 250 in the dash of a car, as illustrated in FIG. 2a, or may be a touch screen 250 typically found behind a seat 260 in front of a passenger area (such as the back of the front seat of a car or an airplane). In one example implementation, an array of simple analog force sensors (which may be of various types) are wired directly to a dedicated onboard computer that processes the raw data, runs the functional software, and generates the output signals for the special feedback components and for the generic onboard infotainment system. The onboard computer system may also generate, download, store and upload the associated system and user data, using the available communication channels. If the vehicle is not equipped with a wireless connection to the cloud, this data could be communicated with a personal electronic device, routinely connected to the vehicle, from where it could be communicated to the cloud using the personal electronic device's standard connection and the dedicated application.

The main output user interface element in this system would be the standard user interfaces 250,which may be touchscreens, that are most commonly built into the seat backs, but also in the dashboards, sometimes in the seat sides (as in aircraft), etc., as illustrated in FIGS. 2a and 2b. Such interfaces 250 can be found in aircraft, coaches, trains, taxis, autonomous cars, etc., and can used as set forth above in the invention.

FIG. 4 illustrates a system 400 configured for evaluating muscular activity of a user during exercise and/or providing feedback to the user in accordance with one or more implementations of the present invention. The system 400 facilitates exercise by a passenger or navigator in a vehicle seating area, including but not limited to the vehicle seating area 202 (FIG. 2). In some implementations, the system 100 may facilitate exercise via a game to encourage users to perform exercise(s). In other implementations, exercise instructions are given to the user and/or a fitness program is provided to the user to encourage users to perform exercise(s).

In some implementations, system 400 may include one or more exercise apparatus 100 positioned within the vehicle seating area 202, one or more processors 106, 410 configured to execute computer-executable instructions and/or other components. In some implementations, the one or more processors 106 may be disposed at the exercise apparatus 100. In some implementations, the one or more processors 410 may be disposed at a computing platform 404 that is onboard the vehicle or a remote computing platform 412, which may include one or more of a game system 414, server 416, mobile electronic device 418 (such as a cellular telephone, a smartphone, a laptop, a tablet computer, a desktop computer, a television set-top box, a smart TV, a gaming console, and/or other computing platform.

As illustrated in FIG. 4, one or more exercise apparatus 100 may be incorporated into a seating area of a vehicle, the exercise apparatus 100 may be wired directly to the vehicle on-board computer platform 404. When such exercise apparatus 100 is incorporated into an aftermarket product, one or more of the exercise apparatus 100 may communicate wireless to a remote computing platform via a network or other wireless communication, including but not limited to Bluetooth communication. In this manner, information from one or more information apparatus 100 (which may be wired together or independently connected to a wireless network) is wirelessly communicated to a computer platform 404 (FIG. 4) and/or computer platform 412, game system 414, server 416 and/or mobile electronic device 418.

Each exercise apparatus 100 includes a user interface component 204 and at least one sensor 102, as well as other components and/or features. Sensor(s) 102 may be disposed at the user interface component 104. The exercise apparatus may include processor(s) 410 for recording and/or processing information regarding loads applied to the exercise apparatus. Alternatively, recorded load data may be sent directly to an onboard computing platform 410 or a remote computing platform 412, 414, 416 and/or 418 for processing on remote processors 410. While the exercise apparatus 100 may include a feedback component 108, a feedback component 408 in also located on the onboard computer platform 414 or remote computing platform 412, 414, 416 and/or 418, along with one or more processors 410, and/or other components, including platform computing user interface components 406.

The one or more sensor 102 in the one or more exercise apparatus 100 may be configured to communicatively couple to the one or more processors 110, 410 (e.g., wired or wirelessly). By way of a non-limiting example, one or more sensor(s) 102 may be configured to communicatively couple to the one or more processors 410 through wireless communications routed through network 402, and/or other communication networks. By way of a non-limiting example, one or more sensors 102 may be configured to communicatively couple to the one or more processors 410 through wired communications between the sensors 102 and computing platform 404. In some implementations, the computer platform 404, 412, 414, 416 and/or 418 may be configured to communicatively couple with an implementation of exercise apparatus 100 the same or similar to that shown in FIG. 1.

In some implementations, the exercise apparatus 100 may facilitate performance of physical exercises including isometric exercise, dynamic exercise, aerobic exercise, anaerobic exercise, flexibility exercise, stretching, resistance exercise, and/or other physical exercise. A given exercise may include performing certain body motions and/or assuming certain body poses. The exercise apparatus 100 may comprise one or more user interface components 104, one or more sensors 102, and/or other components. The user interface component(s) 104 may include physical components. The user interface component(s) 104 may be removable from the exercise apparatus 102. The user interface component(s) 104 may be moveable and/or repositionable upon the exercise apparatus 100. The user interface component(s) 104 may be immovably disposed upon the exercise apparatus 100. The user interface component(s) 104 may be configured to receive forces exerted by a user during performance of one or more exercises.

The user interface component(s) 104 may be configured and/or arranged to engage one or more body parts of the user and/or be positioned/repositioned in an arrangement compatible with a user imparting forces thereon during exercise. In some implementations, the one or more user interface component(s) 104 may include components configured and/or arranged to engage one or more of a finger, a hand, a wrist, an elbow, an arm, a torso, a head, a shoulder, a hip, a thigh, a knee, a calf, an ankle, a foot, and/or any other body part of the user. By way of non-limiting example, a user may impart a force onto one or more user interface components 104 by pressing, pulling, pushing, squeezing, lifting, striking, shaking, twisting, turning, separating, and/or otherwise imparting a force onto one or more of the user interface components 104 or portions thereof. By way of additional non-limiting example, a user may impart a force onto a user interface component 104 configured to engage a hand of a user by squeezing the user interface component 104 (e.g., the user interface component 104 may be hand grip).

In some implementations, individual ones of one or more sensors 102 may be coupled to corresponding ones of the one or more user interface components 104. For example, a first sensor may be coupled to a first user interface component. By way of a non-limiting example, one or more sensors 102 may be coupled to a user interface component 104 configured and/or arranged to engage a hand of a user; one or more sensors 102 may be coupled to a user interface component 104 configured and/or arranged to engage an arm of a user; one or more sensors 102 may be coupled to a user interface component 104 configured to engaged a knee or thigh of a user; and/or other sensors 102 may be coupled to other user interface components 104. It is noted that the above example of various arrangements of sensors 102 and/or user interface components 104 is not to be considered limiting. Instead, it is merely provided as an illustrative example and should not limit the manner in which one or more sensors 102 may be coupled to one or more user interface components 104.

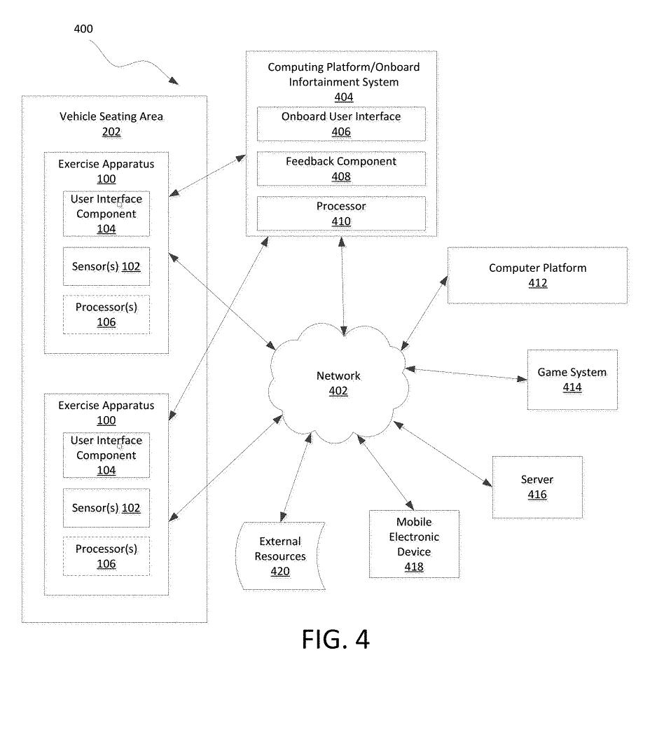

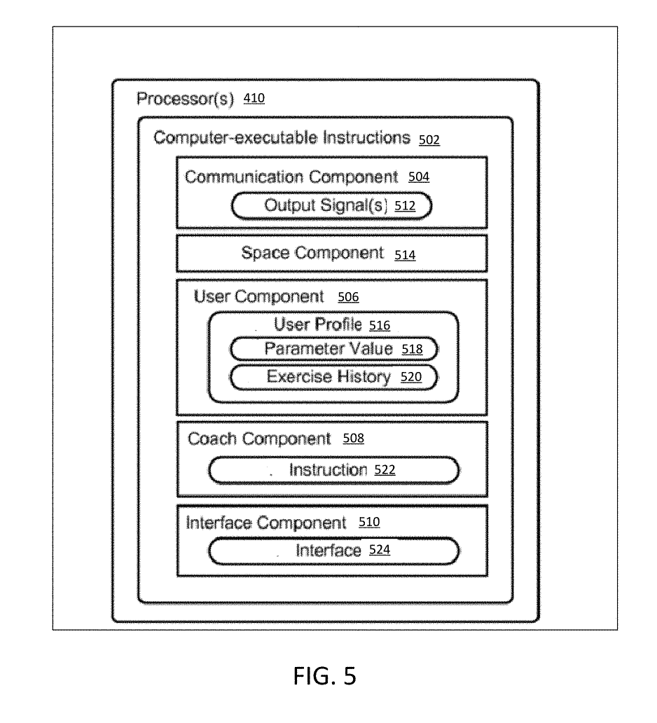

In some implementations, the sensor(s) 102 may be configured to generate output signals conveying information related to one or more parameters of muscular activity of the user performing one or more exercises, and/or other information. Parameters of muscular activity may include one or more of an exercise parameter corresponding to a given exercise performed by the user; a muscle activation parameter corresponding to a muscle and/or muscle group activated by a user during performance of a given exercise; a force parameter corresponding to an amount of force exerted by a muscle and/or muscle group during a given exercise; a repetition parameter corresponding to an amount of repetitions of activation of a muscle and/or muscle group by a user during a given exercise; a time parameter corresponding to an elapsed time of performance of a given exercise and/or an elapsed time between repetitions; an energy parameter corresponding to an amount (e.g., average, total, current, and/or other amount) of energy expenditure by the user during a given exercise and/or repetition (“rep”), and/or other parameter (see, e.g., user component 506 described herein in connection with FIGS. 5 and 6).

The one or more sensors 102 may be configured to communicatively couple (e.g., wired or wirelessly) with the one or more physical processors 106, 410. In implementations where the one or more processors 410 may be disposed at a computing platform 404, 412, 414, 416, and/or 418, the one or more sensors 102 may be configured to communicate with the one or more processors 410 over network 402, and/or over other communication networks. In implementations where the one or more processors 106 may be disposed at the exercise apparatus 100, the one or more sensors 102 may be configured to communicate with the one or more processors 110 via communications routed locally within the exercise apparatus 100 and/or over other communication networks. The one or more physical processors 106 may be configured to obtain the sensor output signals, determine values for the one or more parameters, and/or perform other functions described herein. The processors 106 may then communicate the output signals, calculated values and/or other information to computer networks 404, 412, 414, 416 and 418 either directly via a wired network and/or over network 402 or other communications network.

In some implementations, one or more feedback components 108 may be disposed at the exercise apparatus (see, e.g., FIG. 1 and FIG. 4), and/or other locations. In some implementations, one or more feedback components 408 may be disposed at a computing platform 404 (see, e.g., FIG. 4), and/or other locations (such as computing networks 412, 414, 416 and 418). The one or more feedback components 108, 408 may be configured to communicatively couple with the one or more physical processors 106, 410 and/or with other components.

Processors 106, 410 may be configured to effectuate presentation of exercise instruction and/or other feedback to the user via one or more feedback components 108, 408 and/or perform other functions. It will be recognized that while feedback components 108, 408 may be included as part of the exercise apparatus 100 and the computer platform 404, 412, 414, 416 and 418, certain function described below in connection with the feedback components 108, 408 may be better suited to be performed on the computing platform 404, 412, 414, 416 and 418 than at the exercise apparatus 100. Further, the implementation of the exercise apparatus 100 into various location of the seating area may limit the possibility functions that may be performed by the feedback component 108 of the exercise apparatus 100. In some application, all the feedback functions performed by the feedback component 108 may best be performed by at the computing platform level.

In implementations where the one or more processors 410 may be disposed at a computing platform 404, the one or more feedback components 108 located on the exercise apparatus 100 may be configured to communicate with the one or more processors 410 over network 122, and/or other communication networks (e.g. wired communication network). In implementations where the one or more processors 106 may be disposed at the exercise apparatus 102 (see, e.g., FIG. 1 and FIG. 2), the one or more feedback components 108 located on the exercise apparatus 100 may be configured to communicate with the one or more processors 106 via communications routed locally within the exercise apparatus 100, and/or over other communication networks (wired or wireless).

In implementations where the one or more processors 106 may be disposed at the exercise apparatus 106 and the one or more feedback components 408 are located on a computer platform, the computer platform may be configured to communicate with the one or more processors 106 over network 122, and/or other communication networks (e.g. wired communication network). In implementations where the one or more processors 410 may be disposed at the computer platform, the one or more feedback components 408 on the computer platform may be configured to communicate with the one or more processors 410 via communications routed locally within the computer platform 404, and/or over other communication networks (wired or wireless).

The one or more feedback components 408 may comprise a physical component or set of physical components configured to provide one or more of visual feedback, auditory feedback, tactile feedback, olfactory feedback, and/or other feedback to a user. In some implementations, a feedback component 408 may comprise one or more of a display screen, a light source, an audio speaker, a haptic device, a scent apparatus, a heating element, a fan and/or blower, and/or other components. In some implementations, one or more feedback components 408 may be coupled with one or more user input mechanisms (e.g., a button, a mouse, a joystick, a keyboard, and/or other input mechanism).

A feedback component 108, 408 may include a display screen configured to provide visual feedback. A display screen may include a touch sensitive screen configured to receive user entry and/or selection of information. A display screen may be configured to effectuate display one or more of images, video, text, holograms, and/or other visual display. In some implementations, a display may facilitate presentation of an interface used for gaming, and/or other application (see, e.g., FIG. 5 and FIG. 6, described in more detail herein). In some implementations, a display may be disposed at a user interface component 104, an onboard user interface component 406, computing platform 404, and/or other locations in the system 400.

A feedback component 108, 408 may include one or more light sources configured to provide visual feedback. A light source may include one or more of a light emitting diode (LED), a light bulb, a Chemo-luminescent light source, a lamp, a laser, and/or other source of visible (or invisible) light. In some implementations, a light source may be disposed at a user interface component 104, an onboard user interface component 406, computing platform 404, and/or other locations in the system 400.

A feedback component 108, 408 may comprise one or more audio speakers configured to provide audio feedback. A speaker may be configured to emit a sound (e.g., a buzz, a beep, an alarm, and/or other sound), a song, a recording, a recorded voice, a computer-generated voice, and/or other audio. In some implementations, a speaker may be disposed at a user interface component 104, an onboard user interface component 406, computing platform 404, and/or other locations in the system 400.

A feedback component 108, 408 may include one or more haptic devices configured to provide tactile feedback. A haptic device may include a vibrator and/or other haptic device. A vibrator may include an eccentric rotating mass, and/or other components. In some implementations, a haptic device may be disposed at a user interface component 104, an onboard user interface component 406, computing platform 404, and/or other locations in the system 400.

A feedback component 108, 408 may include one or more heating elements configured to provide heat-based feedback. A heating element may be configured to heat, cool, and/or other produce other heat-based feedback. In some implementations, a heating element may be disposed at a user interface component 104, an onboard user interface component 406, computing platform 404, and/or other locations in the system 400.

A feedback component 108, 408 may include one or more fans and/or blowers configured to provide other feedback. A fan and/or blower may be configured to blow air and/or other gas, draw in air and/or other gas, and/or other performs other operations. In some implementations, a fan and/or blower may be disposed at a user interface component 104, an onboard user interface component 406, computing platform 404, and/or other locations in the system 400.

A feedback component 108, 408 may include a scent apparatus configured to generate a scent to provide olfactory feedback. A scent apparatus may include, for example, an apparatus including a vessel for storing a perfume or other scented substance and a discharge/emission element coupled to the vessel configured to discharge/emit an amount of the substance when triggered/activated. By way of a non-limiting example, a discharge element may include an atomizing pump, a fan, a blower, and/or other components. A scent apparatus may be considered in other ways. In some implementations, a scent apparatus may be disposed at a user interface component 104, an onboard user interface component 406, computing platform 404, and/or other locations in the system 400.

In some implementations, the one or more feedback components 108, 408 may be configured to provide feedback in the form of instructional feedback (e.g., coaching), and/or may provide other information to a user. The feedback provided by a feedback component 108, 408 may be positive, neutral, and/or negative feedback, described in more detail herein. The instruction can be provided in written form, spoken form or in a visual display.

The computer platform 404 that is located onboard the vehicle may also communicate with other computer platforms 412 (such as game systems 414, servers 416, mobile device 418 and external resources 420 over the network 402. For example, the vehicle may be WiFi enable or enabled through a data network to communicate information to remote computer platforms 412). Additionally, the exercise apparatus 100 may communicate directly with mobile devices 418 located with the vehicle seating area, through WiFi or Bluetooth connections, for example, or other communication protocol or network. Similarly, the onboard system can be connected via UBS, Bluetooth or WiFi to communication directly with mobile devices 418 brought into the vehicle seating area. The remote computer platforms may be able to further communicate between one another over the network 402. For example, a mobile device 418 brought within the vehicle seating area may communicate directly with either or both the exercise apparatus 100 or the onboard computer platform 404 as well as a remote computer platform 412 or server 416.

FIG. 5 illustrates one or more processors 410 in accordance with one or more implementations of the present invention. The one or more processors 410 may be configured to execute computer-executable instructions 502. The computer-executable instructions 502 may include one or more of a communication component 504, a space component 514, a user component 506, a coach component 508, an interface component 510, and/or other components. It is noted that the following description may refer to implementations wherein the processor(s) 410 may be one or more of the computing platform and/or onboard infortainment system of the vehicle 404, and/or remote computing platform 412, gaming system 414, server 416, mobile electronic device 418 and/or external resources 420 (as shown in FIG. 4). In some implementations, the components may be executed by different processors, similar to processor 410, disposed at other locations in system 400.

In FIG. 5, the communication component 504 may be configured to facilitate information communication between computer program components of the processor(s) 410, between one or more computer program components and an entity external to the processor(s) 410 (e.g., a feedback component 108, a sensor 102, and/or other entity 100, 404, 412, 414, 416, 418), and/or may facilitate other information exchange(s). By way of a non-limiting example, information communication between two or more computer program components executed by the processor(s) 410 may be routed through the communications component 504, and/or other components. By way of an additional non-limiting example, information communicated to and/or from one or more computer program components of the processor(s) 410 and an entity external to the processor(s) 410 may be routed through the communication component 504, and/or other components.

In some implementations, the communication component 504 may be configured to obtain output signals associated with one or more sensors 102 and/or may obtain other information from the exercise apparatus 100 or other remote system components 404, 412, 414, 416, 418, 420. The communication component 504 may be configured to obtain output signals by virtue of one or both of wired or wireless communications established between the processor(s) 410 and/or 106 (e.g., communication component 504) and one or more sensors 102 or exercise apparatus 100 or other remote device 404, 412, 414, 416, 418, 420, and/or over other communication networks. For example, the communications component 112 may be configured to obtain output signals from the one or more sensors 102 directly (or indirectly, for example, through processor 106). As an illustrative example in FIG. 5, the communication component 504 may be configured to obtain output signal(s) 512.

The space component 514 may be configured to execute an instance of a virtual space and/or game and implement the instance of the virtual space and/or game to facilitate user participation in the virtual space and/or a game that takes place in the virtual space. The executed instance of the virtual space may determine the state of the virtual space. The state may then be communicated to a feedback component 108, 408 (e.g., display) for presentation to a user. The state determined and transmitted to a given feedback component 108, 408 may correspond to a view of a game entity being controlled by a user via an exercise apparatus 100 and/or computing platform 404. The state determined and presented to a given feedback component 108, 408 may correspond to a location in the virtual space (e.g., location in the game). The view described by the state presented by the feedback component 108, 408 may correspond, for example, to the location, from which the view is taken, the location the view depicts, and/or other locations, a zoom ratio, a dimensionality of objects, a point-of-view, and/or parameters of the view. One or more of the view parameters may be selectable by the user.

An instance of the virtual space may comprise a simulated space that is accessible by users via a feedback component 108, 408 that presents the views of the virtual space to a user. The simulated space may have a topography, express ongoing real-time interaction by one or more users, and/or include one or more objects positioned within the topography that are capable of locomotion within the topography. In some instances, the topography may be a one-dimensional topography. By way of non-limiting example of a one-dimensional topography, a game mechanic may include one-dimensional motion that is controlled based on force exerted on exercise apparatus 100 (e.g., more force moves avatar to the left and less force moves avatar to the right).

In one exemplary implementation, two users may control sumo wrestler avatars that move right or left depending on forces applied by the two users to their respective exercise apparatuses 100 so that the velocity of movement is proportional to the difference in the magnitudes of the forces. The second player may be computer generated, a remote user or another passenger in the vehicle seating area. A similar control technique may be applied to games involving arm wrestling, track races, and/or other games that incorporate one-dimensional movement and/or topography. In some instances, the topography may be a two-dimensional topography. In some instances, the topography may be a three-dimensional topography. The topography may include dimensions of the space, and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). An instance executed by the computer components may be synchronous, asynchronous, and/or semi-synchronous.

The above description of the manner in which the state of the virtual space is determined by space component 514 is not intended to be limiting. The space component 514 may be configured to express the virtual space in a more limited, or richer, manner. For example, views determined for the virtual space representing the state of the instance of the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a two-dimensional maze with boundaries/walls/obstacles of which the user must navigate a game entity through to reach an end of the maze. As other examples, a view may include one or more of a skier on a track, sumo wrestlers on a dohyo, arm wrestlers on a table, humans/animals/vehicles on a racing track, and/or other views. Other expressions of individual places within the virtual space are contemplated.

Within the instance(s) of the virtual space executed by space component 514, users may control game entities, simulated physical phenomena (e.g., wind, rain, earthquakes, and/or other phenomena), and/or other elements within the virtual space to interact with the virtual space and/or each other. The game entities may include virtual characters such as avatars. A game entity may be controlled by a user with which it is associated. The user-controlled element(s) may move through and interact with the virtual space (e.g., non-user characters in the virtual space, other objects in the virtual space such as boundaries, obstacles, starting lines, finish lines, and/or other content of a virtual space). Controlling the game entities may include controlling the movement and/or other aspect of the game entities within the virtual space based on control inputs. The user-controlled elements controlled by and/or associated with a given user may be created and/or customized by the given user. The user may have an “inventory” of virtual items and/or currency that the user can use (e.g., by manipulation of a game entity or other user-controlled element, and/or other items) within the virtual space.

The users may participate in the instance of the virtual space by controlling one or more of the available user-controlled game entities in the virtual space. Control may be exercised through control inputs and/or commands input by the users through the exercise apparatus 100, computing platform 404, and/or other input mechanism. In some implementations, one or more values for one or more parameters of muscular activity determined by the user component 506 (described herein), may be provided as control inputs for controlling game entities in the virtual space. Controlling the game entities may include controlling the movement (e.g., positioning) of the game entities within the virtual space.

The users may interact with each other through communications exchanged within the virtual space, or may be located as passengers within the same vehicle seating area. Interaction may also be achieved through computer simulation. Such communications may include one or more of textual chat, instant messages, private messages, voice communications, and/or other communications. Communications may be received and entered by the users via their respective computing platform 404 and/or exercise apparatus 100. Communications may be routed to and from the appropriate users through network 402 and/or through communications which are external to the system 400 (e.g., text messaging services associated with computing platforms 404, 412, 414, 416, 418 and 420).

In some implementations, a virtual space and/or game may be executed by a game system 414 comprising one or more processors (not shown) that may be separate from the exercise apparatus 100, computing platforms 404, 412, 418 and/or server 416. For example, a game system 414 may be provided by some external system 416 may be provided as part of the one or more processors 410.

In FIG. 5, the user component 506 may be configured to access and/or manage a user profile 516 for one or more users. The user component 506 may be configured determine a parameter value 518 for one or more parameters of muscular activity associated with each user profile 404. The user component 506 may be configured to determine exercise history 520 associated with each profile 516. For example, the exercise history 520 may be determined based on the value 518, and/or other information.

The user component 506 may be configured to access and/or manage one or more user profiles and/or user information associated with users. The one or more user profiles and/or user information may include information stored by the exercise apparatus 100, computing platform 404, 412, 414, 418, server 416, and/or other storage locations. The user profiles may include, for example, information identifying users (e.g., a username or handle, a number, an identifier, and/or other identifying information), security login information (e.g., a login code or password), virtual space account information, subscription information, virtual (or real) currency account information (e.g., related to currency held in credit for a user), virtual inventory information (e.g., virtual inventories associated with the users), relationship information (e.g., information related to relationships between users), virtual space usage information (e.g., a login history indicating the frequency and/or amount of times the user logs in to the user accounts and/or participates in a game), information stated by users (e.g., sex, a height, weight, body type, fitness level, body mass index, and/or other information), a computing platform identification associated with a user, a phone number associated with a user, one or more values for parameters of muscular activity associated with the user, an exercise history associated with the user, and/or other information related to user.

In some implementations, the user component 506 may be configured to determine one or more values for one or more parameters of muscular activity associated with the users. The user component 506 may be configured to determine values based on sensor output signals (e.g., obtained from the communications component 504), and/or other information. A value of a given parameter may be numerical (e.g., points, amount, score, rank, ratings, grades, or any other type of numerical expression), descriptive (e.g., text description, and/or other description expression), progressive (e.g., high, medium, low, and/or other progressive expression), pictorial (e.g., an image, a graphic, and/or other visual expression), and/or any other type of expression of a value for a parameter.

In some implementations, the user component 506 may determine values of parameters 518 for the users. A determination may be based on one or more specifications. A specification may include one or more of a function, formula, table, and/or other type of specifications. A given function, formula, table, and/or other type of specification may be stored in electronic storage, and/or other storage location. A given function, formula, table, and/or other type of specification may specify that for a given output signal a given value is allocated for a given parameter. By way of non-limiting illustration, a given function, formula, table, and/or other type of specification may specify that for a given output signal that is directly related to a parameter of muscular activity (e.g., a force measurement sensor that generates output signals conveying force amounts and/or a touch sensor that generates output signals conveying a number of instances of contact the sensor), the value becomes the output signal. By way of non-limiting illustration, a given function, formula, table, or any other type of specification may specify that for a given output signal that is indirectly related to a parameter values 518 of muscular activity (e.g., a position sensor that generates output signals related to displacement used to calculate force, and/or other indirect relationship), a formula may be applied to the output signal and the result of the applied formula becomes the value, and/or other specification. By way of non-limiting example, a first output signals may become a first value for a first parameter. By way of non-limiting example, the result of a first formula applied to a first output signal may become a first value for a first parameter.

By way of a non-limiting example, a parameter value 518 of muscular activity may include an exercise parameter corresponding to a given exercise performed by the user. A type of specification (e.g., a table) may specify that for output signals conveying zero displacement of a sensor coupled to a user interface component, and conveying an amount of force being applied to the same user interface component, the value of the exercise parameter may become “isometric exercise,” and/or other exercise.

By way of another non-limiting example, a parameter value 518 of muscular activity may include a muscle activation parameter corresponding to a muscle and/or muscle group activated by a user during performance of a given exercise. A type of specification (e.g., a table) may specify that for output signals conveying that a user is engaging a particular user interface component 104 (by virtue of a sensor(s) 102 being specifically coupled to the user interface component 104 and generating output signals), a value 518 for the muscle activation parameter becomes a description of the muscle and/or muscle group corresponding to a body part of which the given user interface component 104 is configured to engage. For example, a table may store a list of muscles and/or muscle groups associated various body parts of a user, and may correlate these muscle and/or muscle groups with a particular user interface component configured to engage the corresponding body part.

By way of yet another non-limiting example, a parameter value 518 of muscular activity may include a force parameter corresponding to an amount of force exerted by a muscle and/or muscle group during a given exercise. A type of specification (e.g., a table) may specify that for output signals conveying information related to an amount of force exerted by a user (either directly or indirectly), a value for the force parameter becomes the output signal (for output signals directly related to force) or a result of a formula being applied to the output signal (for output signals indirectly related to force). In some implementations, formulas may be provided by a provider of the system 100 and/or determined based on the configuration of exercise apparatus and/or user interface components, the material properties of the user interface components, the positioning of the sensors generating the output signals, and/or other aspect.

By way of still another non-limiting example, a parameter value 518 of muscular activity may include a repetition parameter corresponding to an amount of repetitions of activation of the muscle and/or muscle group by a user during a given exercise. A type of specification (e.g., a table) may specify that for output signals conveying information related to the number of repetitions performed by the user (either directly or indirectly), a value for the repetition parameter becomes the output signal (for output signals directly related to repetition), a result of a formula being applied to the output signal (for output signals indirectly related to repetition), and/or other specification. By way of non-limiting example, a touch sensor may generate output signals conveying a count of instances of contact with the sensor (e.g., each instance related to one rep). Individual counts may increase a value for the repetition parameter by one unit. By way of non-limiting example, a force measurement sensor may generate output signals that convey a quantification of force as a continuous or discrete waveform corresponding to an application of force by a user. The waveform may convey information related to an application of force followed by a reduction in an application of force. A transition from application to non-application may correspond to a single rep (e.g., associated with an activation of a muscle or muscle group followed by a relaxation of the muscle and/or muscle group).

By way of a non-limiting example, a parameter value 518 of muscular activity may include a time parameter corresponding to an elapsed time of performance of a given exercise and/or an elapsed time between repetitions. The user component 506 may be configured to start a time clock responsive to user input conveying they are beginning an exercise (or rep) and/or based on obtaining a first output signals following a powering on of the exercise apparatus 100 and/or one or more physical processors 106, 410. The user component 506 may be configured to stop a time clock responsive to user input conveying that they ended an exercise and/or based on a timeout period of an absence of output signals following reception of an output signal. A timeout period may be one or more seconds, minutes, and/or other time duration. The user component 506 may be configured to determine a value for the time parameter based on time duration between the start and end and/or between the start and end minus the timeout period, and/or other time duration.

By way of another non-limiting example, a parameter value 518 of muscular activity may include an energy parameter corresponding to an amount of energy expended by the user during a given exercise and/or repetition. Energy expenditure may include calories burned, and/or other measure of energy. A formula or table may be used to determine an amount of energy expended (e.g., average, total, current, and/or other amount) based on one or more of values of other parameters of muscle activity, information about a user (e.g., gender, age, height, weight, body type, fitness level, and/or other information), and/or other information. For example, a formula may be used to determine an amount of calories burned for a person of a given height and/or weight based on an amount of force exerted by a given muscle and/or muscle group and/or other information.

The user component 506 may be configured to determine exercise histories 520 associated with the users. Exercise histories 520 may include historical information associated with the users and/or other information. Historical information may be associated with values for parameters of muscular activity of the users. Historical information may be determined based on the values and/or changes in the values over time. In some implementations, historical information may correspond to one or more aspects of user interaction with an exercise apparatus.

By way of non-limiting example, historical information may correspond to user strength, performance, reactivity, control, overall improvement, and/or other information. Historical information may be used to determine one or more ways to improve, areas of improvement, and/or other information. For example, a first exercise history associated with a first user may convey first historical information based on values or changes in values for a first parameter.

In some implementations, historical information determined based on values and/or changes in values may be expressed numerically (e.g., value, points, amount, score, rank, ratings, grades, or any other type of numerical expression), descriptive (e.g., text description, and/or other descriptive expression), progressive (e.g., high, medium, low, and/or other progressive expression), pictorial (e.g., an image, a graphic, and/or other pictorial expression), and/or any other type of expression used to convey historical exercise information. For example, first historical information may be associated with user strength and/or other aspect. The first historical information may be expressed as a first “strength level,” “moderately strong,” “ 1/10,” an image of a bicep of a particular girth, and/or other expressions.

In some implementations, based on values 518 for a parameter meeting one or more threshold values over time (e.g., over a period of one or more exercises), the user component 506 may be configured to update an exercise history 520 of a user to convey the user has reached or obtained a particular exercise state, and/or other perform other operations. For example, if a value for the first parameter meets a first threshold value, the user component 506 may be configured to include second historical information in the first exercise history 520. The second information may express, for example, a second “strength level,” “very strong,” “3/10,” an image of a bicep of a particular girth, and/or other expressions.

In some implementations, historical information may be presented to a user. Historical information may be represented graphically (e.g., a chart, graph, plot, and/or other graphical representation), audibly, textually, and/or other representation. For example, the changes in values for a parameter may be plotted on a graph with respect to time.

In some implementations, based on historical information conveying that a value of a parameter does not meet a threshold, the user component 506 may be configured to determine which aspects of exercise may need improvement. This may include determining that one or more muscles and/or muscle groups need to be improved in terms of strength, control, reactivity, and/or other aspect. For example, based on the first historical information conveying that the value of the first parameter does not meet a first threshold, the user component 506 may be configured to determine that a first muscle and/or muscle group may need improvement.

The above description of user exercise histories 520 is not intended to be limiting. Instead, it is provided for illustrative purposes and should not be limiting with respect to exercise histories 520, determining historical information from values, presenting historical information to a user, and/or determining ways for improvement based on the historical information. Exercise histories 520 may be determined and/or expressed in other ways.

In FIG. 5, the coach component 504 may be configured to establish an exercise regime to be performed by a user (e.g., including one or more exercises to be performed), provide exercise instructions and/or other feedback to a user based on an exercise regime (e.g., effectuate an activation or triggering of a feedback component 108,408), and/or perform more or less functions.

Establishing an exercise regime to be performed by a user may include one or more of calibrating to a particular user, determining one or more exercises to be performed, and/or other operations. Calibration may include determining user information (e.g., user gender, age, height, weight, fitness level, and/or other information), a maximum threshold of force exertion by a user on individual ones of the one or more user interface components 104, and/or other operations. At least some of the user information may be determined from the user component 506.

Determining maximum threshold(s) may be accomplished by a calibration session instructed to the user, and/or other operations. The coach component 508 may be configured to effectuate a calibration session via a feedback component 108, 408 (e.g., a display) and/or other components. A calibration session may comprise instruction to exert a maximum amount of force onto individual ones of the user interface components 104 using the corresponding muscles and/or muscle groups, or combinations of user interface components 104 by the user. A calibration session may comprise instruction to assume a pose while exerting a force onto individual ones of the user interface components 104 using the corresponding muscles and/or muscle groups, or combinations of user interface components 104 by the user. The communication component 504 may be configured to receive sensor output signals during the calibration session. The user component 506 may be configured to determine values for a force parameter or other parameter associated with individual ones of the user interface components 104 based on the sensor output signals, and/or may associate the values to a muscle and/or muscle group activated by the user according to a corresponding user interface component 104. The user component 116 may be configured to store these determined values as “maximum threshold” force values associated with a corresponding user interface component 104 and/or muscle and/or muscle group of a user. Calibration may include other operations.

Determining one or more exercises to be performed by a user may be accomplished in a variety of ways. In some implementations, an exercise to be performed by a user may be determined based on user entry and/or selection via a feedback component 108, 408 and/or computing platform 404 specifying a desired exercise. In some implementations, an exercise to be performed by a user may be determined simply by the user performing a given exercise. In some implementations, determining one or more exercises to be performed by a user may be based on exercise histories 520 associated with the users. In some implementations, determining one or more exercises to be performed by a user may be based on a calibration session (e.g., the maximum threshold values). For example, the coach component 508 may be configured to store a list or table of various exercises that may be performed to increase strength, power, agility, control, and/or other aspect of a muscle and/or muscle group. The coach component 508 may be configured to store a list or table of typical or “average” or target maximum threshold forces for an individual of a given weight, height, fitness level (e.g., determined based on statistical analysis of individuals, such as a 50.sup.th percentile average, 60.sup.th percentile average, and/or other information). The coach component 508 may be configured to compare the maximum threshold values (and/or values associated with the exercise histories) for a given user and compare these values to those in the list or table of target values. Based on the comparison, the coach component 508 may be configured to determine individual ones of the values that may be less than a corresponding average value. The coach component 508 may be configured to determine one or more exercises to be performed by a user in order to bring the value(s) up to the target (e.g., over time by performing one or more select exercises). Other ways in which exercises may be determined for a user are also contemplated.

The coach component 508 may be configured to effectuate presentation of exercise instruction 522 via one or more feedback components 108, 408 prior to, during, and/or after an exercise. Effectuating presentation of exercise instruction 522 via one or more feedback components 108, 408 may include sending one or more activation and/or triggering signals or messages (e.g., via communication component 504) to a given feedback component 108, 408.

In some implementations, instruction 522 may be related to coaching the user on exerting forces on the one or more user interface components 104. The instruction 522 may be related to coaching the user to activate one or more muscles and/or muscle groups. The instruction 522 may be related to coaching the user to exert a predefined amount of force. The instruction 522 may be related to coaching the user to exert a percentage of their maximum threshold force. The instruction 522 may be related to coaching the user to exert a force for a predefined amount of time. The instruction 522 may be related to coaching the user to exert a force for a predefined number of repetitions. The instruction 522 may be related to any combination of instructions as described herein.

In some implementations, instruction 522 may include feedback related to coaching a user during a currently preformed exercise, providing instructions on how to perform one or more subsequent exercises, providing feedback on a previously performed exercise, and/or other feedback. Instructional feedback may include feedback on how to use a select muscle and/or muscle group, how to engage one or more user interface components 104, encouraging feedback, corrective feedback, neutral feedback, and/or other feedback. By way of non-limiting example, such instructional feedback may be related to a number of reps a user should do, an amount of force (or change in an amount of force) a user should impart during a rep, a frequency of performance of a rep, an amount of time a user should perform one or more exercises and/or reps, an indication to change a select muscle and/or muscle/group being activated to a different muscle and/or muscle group, and/or other instruction. In some implementations, instructional feedback may be provided in real time as the user is performing an exercise and/or rep, prior to the user starting to perform an exercise and/or rep, after an exercise or rep is performed, and/or at other times.

In some implementations, instructional feedback may include instruction 522 that a given user interface component 104 should be engaged by a user, that a given muscle and/or muscle group should be activated by the user with a given user interface component 104, and/or other instruction. One or more of visual feedback, auditory feedback, tactile feedback, olfactory feedback, and/or other feedback may facilitate indicating to a user which user interface component 104 to engage and/or muscle and/or muscle group to activate. For example, a first feedback component may be activated and/or trigger to provide first instructional feedback to a user.

By way of non-limiting example, a given feedback component 108, 408 (e.g., a vibrator, a heating element, a light source, a scent apparatus, a display, a speaker, and/or other feedback component) coupled to a given user interface component 104 (wired or wirelessly) configured to engage a given body part of a user, may be activated and/or triggered (e.g., may vibrate, heat up/cool down, emit light, emit a scent, display an image, graphic and/or text, alert a sound, and/or other feedback) to indicate that the corresponding user interface component 104 should be engaged using the corresponding body part. By way of additional non-limiting example, a feedback component 108, 408 may be activated a certain number of times to indicate a certain number of repetitions of muscle and/or muscle group activation should be performed with the given user interface component 104. In some implementations, the triggering and/or activation of a feedback component 108 may be achieved by the one or more physical processors 106, 410, described herein.

In some implementations, feedback may include feedback that responds to user activity and/or user interaction with the user interface component 104 during a currently preformed exercise, and/or other feedback. Feedback responding to user activity and/or interaction may include activation of one or more feedback components 108 based on a sensor output received from one or more sensors 106 indicating particular action or activity by the user, and/or other aspect of user interaction. For example, responsive to reception of a first output signal (e.g., by the one or more physical processors 110), a first feedback component may be triggered/activated.

By way of non-limiting example, if a user is instructed to engage a given user interface component 104, responsive to one or more sensors 106 generating output signals related to the user contacting the given user interface component 104, one or more feedback components 108 may be activated to indicate the user has successfully followed the instructions. By way of additional non-limiting example, if a user is instructed to exert a given amount of force on a given user interface component 104, responsive to one or more sensors 106 generating output signals related to the user contacting the given user interface component 104 and exerting the instructed amount of force (e.g., based on the output signals being used to determine a value for a force parameter), one or more feedback components 108 may be activated to indicate the user has successfully followed the instructions. In some implementations, feedback may be provided that may indicate a user has unsuccessfully followed instructions.

By way of non-limiting example as to the evolution of instructional feedback being provided to a user, the coaching component 508 may be configured to effectuate presentation of exercise instruction 522 via a feedback component 108, 408. The communication component 504 may be configured to obtain output signals from one or more sensors 102 coupled to one or more user interface components 104 of an exercise apparatus 100. The user component 506 may be configured to determine values for the one or more parameters of muscular activity based on the output signals. The coach component 508 may be configured to modify the presented exercise instruction based on the determined values. For example, if the determined values indicate that the user successfully followed instructions for a given exercise, the instruction 522 may be changed to instruct the user to perform one or more other exercises, and/or other actions and/or activities. As another example, if the determined values indicate that the user has not successfully followed instructions 522 for a given exercise, the instruction 522 may be changed to instruct the user to perform the same exercise again or in a different manner, perform one or more different exercises, and/or other instruction. In some implementations, the modification may correspond to coaching the user to continue exerting forces using a given muscle and/or muscle group, to exert forces using a different muscle and/or muscle group, and/or other modification. In some implementations, the modification may include presenting different instructional feedback.

The above description of the manner in which feedback may be provided to a user via a feedback component 108, 408 is not intended to be limiting. One or more feedback components 108, 408 may be configured to effectuate visual feedback, auditory feedback, tactile feedback, olfactory feedback, and/or other feedback in a more limited, or richer, manner. By way of non-limiting example, instructional information 522 displayed on a screen may be selected from a set of graphics or text conveying to the user a particular exercise to perform, user interface component 104 to engage, muscle and/or muscle group to activate, and/or other information. The displayed information may be accompanied by additional content (e.g., audio, pre-stored video, scents, vibrations, sounds, light emissions, and/or other content) that describes one or more aspects of exercise and/or user performance that go beyond the graphics and/or text. For example, a view displayed on a display screen may include a generic textual description of a given user interface component 104 the user should engage and/or an amount of force the user should try to impart on the given user interface component 104; a vibrator coupled to the given user interface component 104 may simultaneously be activated; a scent may be emitted in response to the user engaging the appropriate given user interface component 104 (e.g., based on sensor output indicating a contact of the user interface component 104 by the user, and/or other sensor output); and/or more or less feedback may be provided. Other ways in which feedback and/or combinations of feedback may be presented to a user are contemplated.

In some implementations, interface component 510 may be configured to effectuate presentation of an interface via a feedback component 108, 408 (e.g., a display/screen). The interface component 510 may be configured to effectuate presentation of views of a virtual space and/or game executed by the space component 514. The interface component 510 may be configured to effectuate presentation of an interface including one or more of: a portion conveying a view of a game taking place in a virtual space executed by the space component 514, the game including a game entity controlled by a user and/or other virtual space content; a game control element configured to receive user entry and/or selection to control one or more aspects of gameplay; a portion conveying information related to control inputs for controlling a game entity in a game space; a portion conveying information related to values for one or more parameter of muscle activity associated with a user; and/or other portions.

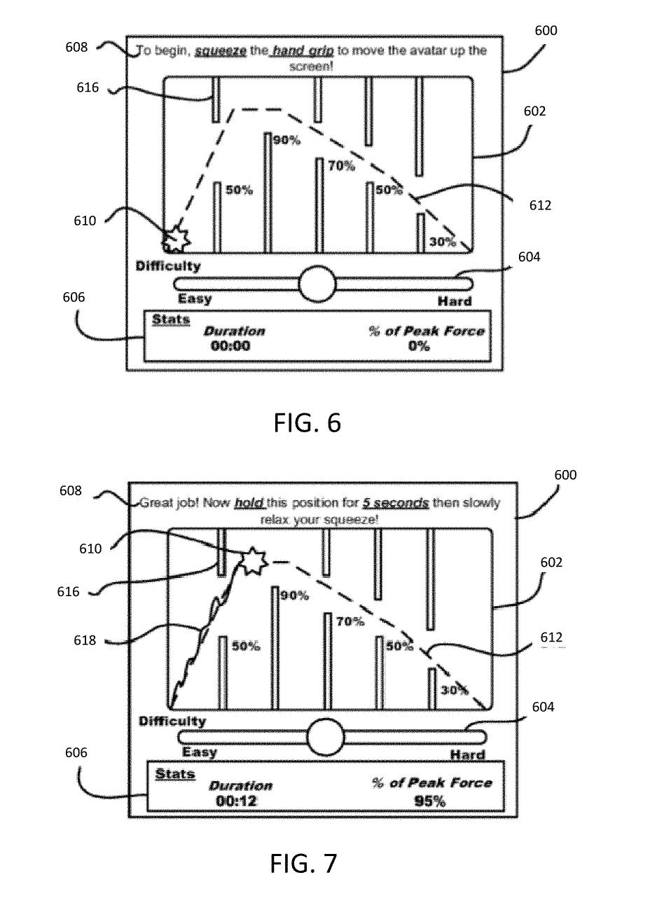

By way of non-limiting illustrations in FIG. 6 and FIG. 7, an implementation of an interface 600 for exercise program and/or gaming program controlled by exercise is depicted. The interface 600 may include one or more interface elements and/or portions. The interface elements and/or portions may comprise one or more of: a play portion 602 including an entity 610 associated with a user, and play elements such as a path 612 and obstacles 616; a control element 604 for controlling one or more aspects of play; an information display portion 606 configured to display play information; an instruction portion 608 configured to display exercise instructions; and/or other portions and/or elements. The depiction of interface 600 in FIGS. 6 and 7 is not intended to be limiting as interface 600 may include more or less elements than is shown. For example, in some implementations, one or more elements may be omitted from interface 600. As another example, the functionality described in connection with two or more elements may be combined as a single element.

In some implementations, the play portion 602 may represent a graph showing magnitude of the force (e.g., y-axis) that the user is expected to exert over time (e.g., x-axis). The path 612 (e.g., dashed line) may be the target force curve that the user has to follow over time. The width of the openings in the obstacles 616 (e.g., vertical bars) may determine the tolerance around the target curve where the performance is considered correct. The horizontal density of the vertical bars may determine the number of control points where performance precision is evaluated. The farther from the opening the game entity 610 (e.g., star) crosses the bar, the less precision may be recorded. The horizontal density and the opening width of the bars may be controlled with the control element 604 (e.g., difficulty slider)—more difficulty may be more bars and narrower openings, which may force the user to be much closer to the target curve. The user may be awarded different amounts of award points depending on the difficulty level chosen and precision achieved during execution. The information display portion 606 may be configured to enable the user to change the overall duration of the exercise repetition and/or to change the value of the highest point on the curve, as percentage of the calibrated force for the specific pose. Changing peak force may result in stretching the curve vertically. In some implementations, the user can may change the pose, the number of repetitions, the rest between repetitions, and/or other aspects of the exercise. In some implementations, the entity 610 may represent the current force value. The entity 610 may move with even velocity left to right as repetition time runs. Meanwhile the entity 610 may also move vertically with variable velocity, depending on the changes in the exerted force.

In some implementations, a graphical “skin” may be applied to the interface 600. For example, the interface 600 may be depicted such that the path 612 may be a ski track, the openings between opposing obstacles 616 may be shown as poles, and the obstacles 616 may be replaced with obstacles of different types (e.g., rocks, pine trees, and/or other types). For graphical relevance, the interface 600 may be rotated 90 degrees. The entity 610 may be depicted as a skier moving down. More force may move the skier right while less force may move the skier left.

In some implementations, the user may be instructed to move the entity 610 through a maze comprising the path 612, obstacles 616, and/or other elements. The path 612 may be associated with moving the entity 610 over the obstacles 616 and across the screen (e.g., in the current depiction, from left to right). At the start of play, the game entity 610 may automatically begin moving horizontally across the screen. This may be similar to a type of “side scrolling” game, and/or other game. However, in some implementations, control inputs may be provided by a user which may determine an amount of horizontal movement of the entity 610. In some implementations, the user may provide inputs in a manner to maneuver the entity 610 vertically in the application to overcome the obstacles 616 and successfully move the entity 610 to the other end of the maze. In some implementations, the control inputs for controlling a vertical position of the entity 610 may be associated with user interaction with user interface components of one or more exercise apparatus. By way of non-limiting example, by exerting a force (e.g., squeezing) on a user interface component using a body part (e.g., their hands) output signals from one or more sensors may be generated. The output signals may be used to determine values for a force parameter and/or other parameter. The values may be provided as control inputs to move the entity 610 vertically, and/or in other directions. For example, a quantification of force may correspond to an amount of movement of the entity 610.

In some implementations, traversing an obstacle 616 may include exerting an amount of force required to move the entity 610 to an appropriate position. The requisite amount may be provided to the user via instruction 608 presented to the user. The requisite amount may be shown in the play portion 602. For example, adjacent each obstacle 616 may include a maximum threshold percentage amount required to appropriately position the entity 610 to traverse the obstacles 616.

The control element 604 may facilitate controlling one or more aspects of play. In the current figure, difficulty may comprise at least one of the aspects of play that may be controlled. Other aspects may include a size of the maze, a type of game (e.g., race game, and/or other game), and/or other aspects. Other aspects are also contemplated. By way of a non-limiting example, the control element 604 may comprise a sliding indicator which may allow a user to change a difficulty (or other aspect) between relatively easier to relatively harder. In some implementations, an “easy” game may be associated with less force required to overcome obstacles 616; the entity 610 moving slower across the screen; and/or other game aspects. A relatively “harder” game may require more force and/or the entity 610 may move faster, and/or other game aspects may be different. It is noted that the control element 604 may be any type of element configured to receive user entry and/or selection. For example, control element 604 may be a drop-down menu presenting a list of selectable options, a series of check boxes of which the user may select as desired, and/or other control element.

Information display portion 606 may be configured to display play information and/or other information. Play information may include one or more of a current state of control inputs provided by the user (e.g., a current percentage of maximum force exerted by the user and/or other information), a time clock, and/or other information.

The instruction portion 608 may be configured to display exercise instructions as part of the play experienced by a user. The exercise instruction 608 may be related to play, one or more exercises, and/or other instruction. As such, the presentation of exercise instruction and gaming may be seamlessly integrated.

FIG. 7 illustrates an implementation of play by a user. Play may correspond to controlling the entity 610 in the virtual space. The movement of the entity 610 may be represented by a trail 618 corresponding to the real time control inputs provided by the user over time.

In some implementations, play may include multiplayer gameplay, and/or other gameplay. For example, a game may be executed which includes a gaming space, including a first game entity associated with a first user and a second game entity associated with a second user. Views of the game may be presented to the users on a common screen (if they are proximate each other) or on separate displays associated with the users, respectively. The users may then “battle” by controlling the respective game entities using control inputs derived from forces imparted on respective exercise apparatuses associated with the users to achieve a game objective (e.g., complete a maze, and/or other objective).

It is noted that the above description of gameplay using control input determined from sensor output generated during user interaction with an exercise apparatus is not intended to be limiting. Instead, this is provided as an illustrative example and is not intended to limit the way in which control inputs may be provided, a game entity may be controlled, the manner in which gameplay may commence, and/or other aspects related to gaming using an exercise apparatus in accordance with one or more implementations presented herein.

For purposes of illustration, the game and gameplay may also be an exercise or fitness program, and may not necessarily implemented in the form of a “game,” but rather a fitness program with fitness goals and exercise instruction.

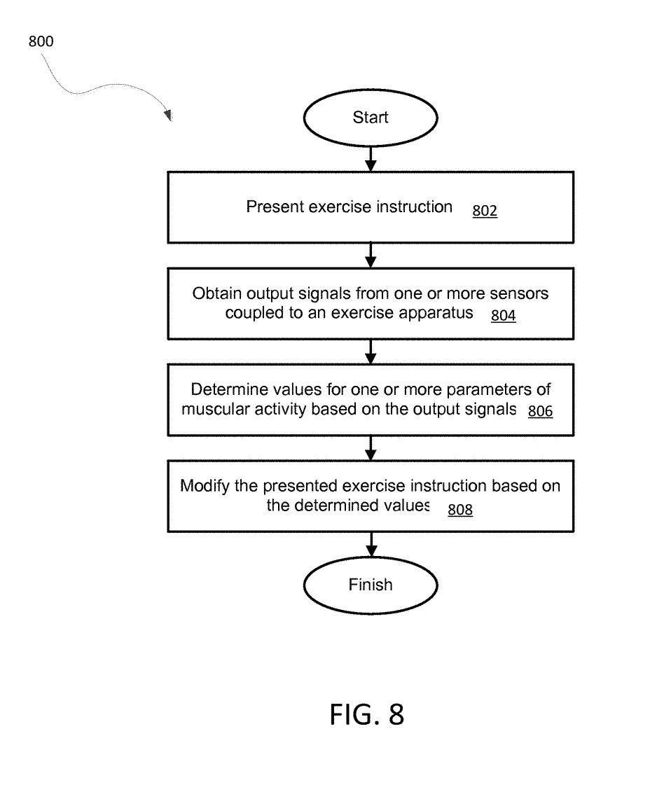

FIG. 8 illustrates a method 800 of coaching a user performing one or more exercises, in accordance with one or more implementations of the present invention. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 8 and described below is not intended to be limiting.

In some embodiments, method 800 may be implemented in one or more processing devices (e.g., a digital processor, an analog processor, a digital circuit designed to process information, an analog circuit designed to process information, a state machine, a functionally limited processing device, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

Referring now to method 800 in FIG. 8, at operation 802, presentation of exercise instruction may be effectuated. The instruction may relate to coaching a user on exerting forces on an exercise apparatus using one or more muscles and/or muscle groups in accordance with one or more exercises. In some implementations, operation 802 may be performed by a coach component the same as or similar to coach component 508 (shown in FIG. 5 and described herein).

At operation 804, output signals from one or more sensors coupled to the exercise apparatus may be obtained. The output signals may convey information related to one or more parameters of muscular activity of the user during the exercises. In some implementations, operation 804 may be performed by a communication component the same as or similar to the communication component 504 (shown in FIG. 5 and described herein).

At operation 806 values for the one or more parameters of muscular activity may be determined based on the output signals. The parameters may correspond to one or more of a muscle and/or muscle group activated by the user during performance of the given exercise, an amount of force exerted by the muscle and/or muscle group during the given exercise, an amount of repetitions of activation of the muscle and/or muscle group, an elapsed time of performance of the given exercise, an amount of calories burned, and/or other aspects of muscular activity. In some implementations, operation 806 may be performed by a user component the same as or similar to the user component 506 (shown in FIG. 5 and described herein).

At an operation 808, modification of the presented exercise instruction may be effectuated based on the determined values. The modification may correspond to coaching the user to continue exerting forces using a given muscle and/or muscle group or to exert forces using a different muscle and/or muscle group. In some implementations, operation 808 may be performed by a coach component the same as or similar to coach component 508 (shown in FIG. 5 and described herein).

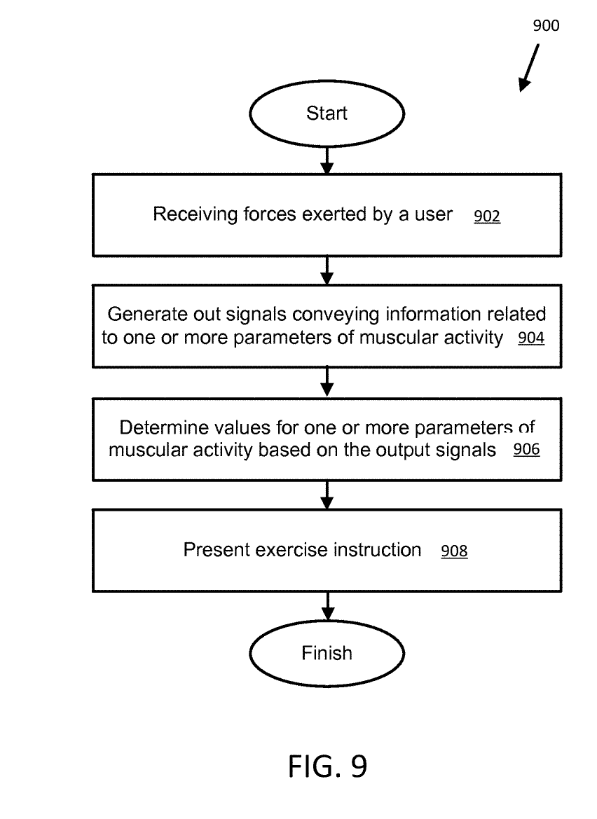

FIG. 9 illustrates a method 900 of evaluating muscular activity of a user during exercise and/or providing feedback to the user, in accordance with one or more implementations of the present invention. The operations of method 900 presented below are intended to be illustrative. In some embodiments, method 900 may be accomplished with one or more additional operations not described, and/or without one or more of the operations discussed. Additionally, the order in which the operations of method 900 are illustrated in FIG. 9 and described below is not intended to be limiting.

In some embodiments, method 900 may be implemented using an exercise apparatus (see, e.g., exercise apparatus 100 of FIG. 1) including one or more processing devices (e.g., a digital processor, an analog processor, a digital circuit designed to process information, an analog circuit designed to process information, a state machine, a functionally limited processing device, and/or other mechanisms for electronically processing information), one or more user interface components configured to engage one or more body parts of a user and receive forces exerted by the user during performance of one or more exercises (see, e.g., user interface components 104 of FIG. 1), one or more sensors configured to generate output signals conveying information related to one or more parameters of muscular activity (see, e.g., sensors 102 of FIG. 1), one or more feedback components configured to provide feedback to a user (see, e.g., feedback components 408 of FIG. 4), and/or other components. The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

Referring now to method 900 in FIG. 9, at operation 902, forces exerted by a user during performance of one or more exercises may be received. In some implementations, operation 902 may be facilitated by one or more user interface components the same as or similar to one or more user interface components 104 (shown in FIG. 1 and described herein).

At operation 904, output signals may be generated. The output signals may convey information related to one or more parameters of muscular activity of the user during the exercises. In some implementations, operation 904 may be facilitated by a one or more sensors the same as or similar to one or more sensors 102 (shown in FIG. 1 and described herein). The one or more sensors may be coupled to individual ones of the user interface components 104.

At operation 906, values for the one or more parameters of muscular activity may be determined based on the output signals. The parameters may correspond to one or more of a muscle and/or muscle group activated by the user during performance of the given exercise, an amount of force exerted by the muscle and/or muscle group during the given exercise, an amount of repetitions of activation of the muscle and/or muscle group, an elapsed time of performance of the given exercise, an amount of calories burned, and/or other muscular activity. In some implementations, operation 906 may be performed by one or more physical processors the same as or similar to the processors 410 (shown in FIGS. 4 and 5 and described herein).

At operation 908, exercise instruction may be presented to a user. The instruction may correspond to coaching the user to continue exerting forces using a given muscle and/or muscle group or to exert forces using a different muscle and/or muscle group. In some implementations, operation 908 may be facilitated by one or more feedback components the same as or similar to one or more feedback component 908 (shown in FIG. 1 and described herein).

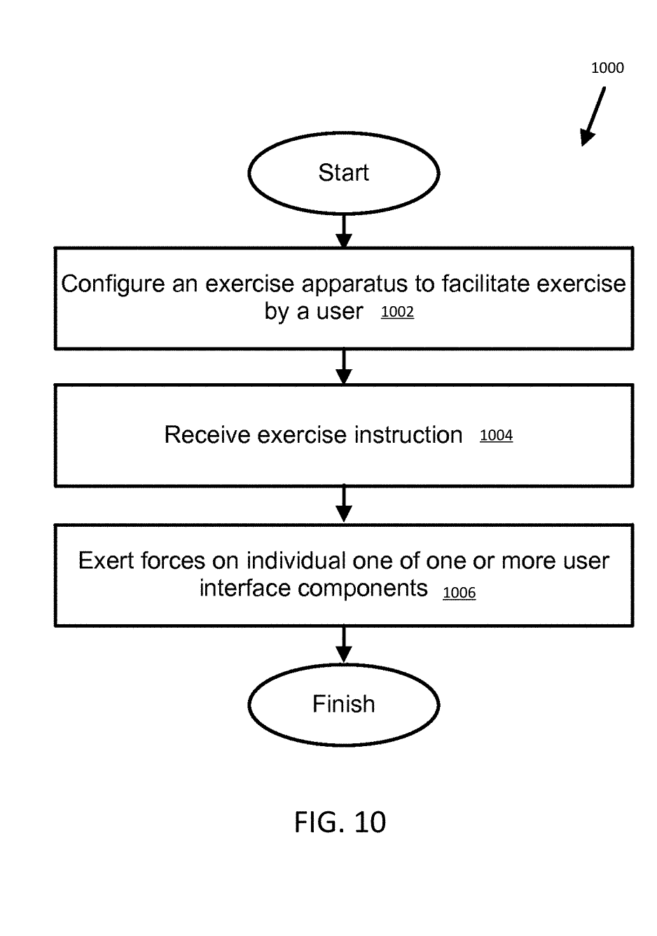

FIG. 10 illustrates a method 1000 of using an exercise apparatus 100, in accordance with one or more implementations of the present invention. The operations of method 1000 presented below are intended to be illustrative. In some embodiments, method 1000 may be accomplished with one or more additional operations not described, and/or without one or more of the operations discussed. Additionally, the order in which the operations of method 1000 are illustrated in FIG. 10 and described below is not intended to be limiting.

In some embodiments, method 1000 may be implemented by a user using an exercise apparatus (see, e.g., exercise apparatus 100 of FIG. 1) including one or more processing devices (e.g., a digital processor, an analog processor, a digital circuit designed to process information, an analog circuit designed to process information, a state machine, a functionally limited processing device, and/or other mechanisms for electronically processing information), one or more user interface components configured to engage one or more body parts of a user and receive forces exerted by the user during performance of one or more exercises (see, e.g., user interface components 104 of FIG. 1-3), one or more sensors configured to generate output signals conveying information related to one or more parameters of muscular activity (see, e.g., sensors 102 of FIG. 1), one or more feedback components configured to provide feedback to a user (see, e.g., feedback components 408 of FIG. 4), and/or other components.

FIG. 10, at an operation 1002, an exercise apparatus 100 may be configured to facilitate one or more exercises by a user. In some implementations, the exercise apparatus 100 may be configured for engaging a user in a substantially seated position. In some implementations, the exercise apparatus 100 may be configured by moving and/or repositioning one or more user interface components 104 that are configured to receive forces exerted by the user. In some implementations, operation 1002 may be facilitated by an exercise apparatus the same as or similar to exercise apparatus 100 (shown in FIG. 1 and described herein) as incorporated in to a seating area or seat and/or the environment surround the seat, including but not limited to the seating area and seat shown and described in connection with FIGS. 2 and 3.

At operation 1004, exercise instructions may be received. In some implementations, operation 1004 may be facilitated by one or more feedback components the same as or similar to one or more feedback component 408 (shown in FIG. 4).

At operation 1006, forces may be exerted on one or more user interface components 104 of the exercise apparatus 100. In some implementations, operation 1006 may be facilitated by one or more user interface components the same as or similar to one or more user interface components 104 (shown in FIG. 1 and described herein) and/or one or more user interface components 104 shown in FIGS. 2 & 3.

In the FIGs. the exercise apparatus 100, processor(s) 106, 410, sensor(s) 102, feedback component(s) 108, 408, computing platform(s) 404, 412, game system 414, server 416, mobile devices 418 and/or external resources 420 may be operatively linked via one or more electronic communication links. For example, such electronic communication links may be established, at least in part, via a network 402 such as a local area network, a wide area network (e.g., the Internet), a short range communication network (e.g., Bluetooth, near-field communication, infrared, and/or other short range network), a wired network (e.g., ethernet, USB, firewire, and/or other wired network), and/or other networks. It will be appreciated that this is not intended to be limiting, and that the scope of this disclosure includes implementations in which exercise apparatus 100, processor(s) 106, 410, sensor(s) 106, feedback component(s) 108, 408 computing platform(s) 404, 412, game system 414, server 416, mobile devices 418 and/or external resources 420, may be operatively linked via some other communication media.

The external resources 420 may include sources of information, hosts and/or providers of information outside of system 400, external entities participating with system 400, and/or other resources. In some implementations, some or all of the functionality attributed herein to external resources 420 may be provided by resources included in system 400.

The exercise apparatus 100, computing platform(s) 404, 412, game system 414, server 416 and/or mobile devices 418 may include electronic storage, one or more processors 106,410, and/or other components. The exercise apparatus 100, computing platform(s) 404, 412, game system 414, server 416 and/or mobile devices 418 may include communication lines or ports to enable the exchange of information with a network and/or other computing platforms. Illustration of exercise apparatus 100, computing platform(s) 404, 412, game system 414, server 416, mobile devices 418 and/or external resources 420 in FIG. 4 is not intended to be limiting. The exercise apparatus 100, computing platform(s) 404, 412, game system 414, server 416, mobile devices 418 and/or external resources 420 may include a plurality of hardware, software, and/or firmware components operating together to provide the functionality attributed herein to the exercise apparatus 100, computing platform(s) 404, 412, game system 414, server 416, mobile devices 418 and/or external resources 420, respectively.

Electronic storage may comprise electronic storage media that electronically stores information. The electronic storage media of electronic storage may include one or both of system storage that is provided integrally (i.e., substantially non-removable) with exercise apparatus 100, computing platform(s) 404, 412, game system 414, server 416, mobile devices 418 and/or external resources 420 connectable to exercise apparatus 100 via, for example, a port or a drive. A port may include a USB port, a firewire port, and/or other port. A drive may include a disk drive and/or other drive. Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). Electronic storage may store software algorithms, information determined by processor(s) 106, 410, information received from one or more of exercise apparatus 100, computing platform(s) 404, 412, game system 414, server 416, mobile devices 418, external resources 420 and/or other information that enables exercise apparatus 100, computing platform(s) 404, 412, game system 414, server 416, mobile devices 418 and/or external resources 420 to function as described herein.

Processor(s) 106, 410 is configured to provide information-processing capabilities in exercise apparatus 100, computing platform(s) 404, 412, game system 414, server 416, mobile devices 418 and/or external resources 420. As such, processor 106, 410 may include one or more of a digital processor, an analog processor, a digital circuit designed to process information, an analog circuit designed to process information, a state machine, and/or other mechanisms for electronically processing information. Although processor is shown in FIG. 1 (106) and FIGS. 4 and 5 (410) as a single entity, this is for illustrative purposes only. In some implementations, processor 106, 410 may include one or more components. These components may be physically located within the same device, or processor 106, 410 may represent processing functionality of a plurality of devices operating in coordination.

The processor 106, 410 may be configured to execute components 502, 514, 516, 508 and/or 510. Processor 106, 410 may be configured to execute components 502, 514, 516, 508 and/or 510 by software; hardware; firmware; some combination of software, hardware, and/or firmware; and/or other mechanisms for configuring processing capabilities on processor 106, 410.

It should be appreciated that, although components 502, 514, 516, 508 and/or 510 are illustrated in FIG. 5 as being co-located within a single component, in implementations in which processor 106, 410 includes multiple components, one or more of components 502, 514, 516, 508 and/or 510 may be located remotely from the other components. The description of the functionality provided by the different components 502, 514, 516, 508 and/or 510 described above is for illustrative purposes and is not intended to be limiting, as any of components 502, 514, 516, 508 and/or 510 may provide more or less functionality than is described. For example, one or more of components 502, 514, 516, 508 and/or 510 may be eliminated, and some or all of its functionality may be provided by other ones of components 502, 514, 516, 508 510, and/or other components. As another example, processor 106, 110 may be configured to execute one or more additional components that may perform some or all of the functionality attributed to one of components 502, 514, 516, 508 and/or 510.

It will be understood, and is appreciated by persons skilled in the art, that one or more processes, sub-processes, or process steps described above and in connection with the figures may be performed by hardware and/or software. If the process is performed by software, the software may reside in software memory (not shown) in a suitable electronic processing component or system such as, one or more of the functional components or modules. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

An electronic processing component or system such as, one or more of the functional components or modules, may be directly connected to one other or may be in signal communication. It will be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A system for facilitating exercise by a passenger or navigator of a vehicles while in a passenger area of the vehicle, the system incorporates one or more force sensors into the passenger area of the vehicle surrounding the passenger and/or navigator in the vehicle, where the one or more sensors are positioned within the vehicle passenger area to engage one or more body parts of passenger and/or navigator in exercise by applying repeated force on the one or more force sensors.

2. The system of claim 1 further including a computer platform in communication with the one or more force sensors in the vehicle passenger area, the computer platform including computer executable software for coaching the passenger and/or navigator on how engage the one or more force sensors in the vehicle seating area to engage in isometric exercise while seated in the vehicle by applying force using various body parts to the one or more force sensors.

3. The system of claim 1 further including a computer platform in communication with the one or more force sensors in the vehicle passenger area, wherein the computer platform includes computer executable gaming software responsive to force applied to the one or more force sensors.

4. The system of claim 1 further including a computer platform in communication with the one or more force sensors in the vehicle passenger area, wherein the computer platform includes computer executable fitness software responsive to force applied to the one or more force sensors.

5. The system of claim 1 further including a computer platform in communication with the one or more force sensors in the vehicle passenger area, wherein the computer platform includes computer executable software for quantifying and recording the force applied to the one or more force sensors.

6. The system of claim 1 where the one or more force sensors are incorporated into a steering wheel, where applying force to the steering wheel engages the navigator of the vehicle in isometric exercise and where the one or more force sensors record the force applied.

7. The system of claim 1 where the one or more force sensors are incorporated into a dash of the vehicle seating area, just under predetermined locations on the dash, where applying force on the dash above the one or more force sensors engages the passenger and/or navigator of the vehicle in isometric exercise, and where the one or more force sensors record the force applied.

8. The system of claim 1 where the one or more force sensors are incorporated into an arm rest, where applying force to an arm rest engages the navigator of the vehicle in isometric exercise, and where the one or more force sensors record the force applied.

9. The system of claim 1 where the one or more force sensors are incorporated into a foot rest, where applying force to a foot rest engages the navigator and/or passenger in isometric exercise and where the one or more force sensors record the force applied.

10. The system of claim 1 where the one or more force sensors are incorporated into a vehicle seat, where applying force to certain areas of a seat engages the navigator of the vehicle in isometric exercise and where the one or more force sensors record the force applied.

11. The system of claim 2 where the computer platform receives data recorded by the one or more force sensors regarding the duration and application of force on the one or more force sensors to track and measure user performance and to provide feedback instruction to the passage and/or navigator engaging the one or more force sensors.

12. A system for facilitating exercise by a user riding in a vehicle while seated in a seating area of the vehicle, the system incorporates one or more exercise apparatus into the seating area of the vehicle, where the exercise apparatus are positioned within the vehicle seating area to engage one or more body parts of the user in exercise by applying force on the exercise apparatus.

13. The system of claim 12 where the exercise apparatus includes at least one sensor for measuring force applied to the exercise apparatus.

14. The system of claim 13 where the exercise apparatus is communication with a computer platform and where the exercise apparatus communicates the measured force applied to the exercise apparatus to the computer platform.

15. The system of claim 13 where the computer platform including computer executable software for coaching the user on how engage the exercise apparatus in the vehicle seating area to engage in isometric exercise while seated in the vehicle.

16. The system of claim 12, wherein the one or more exercise apparatus are configured and arranged in the vehicle seating area to engage one or more of a hand, a wrist, an elbow, an arm, a torso, a head, a shoulder, a back, a hip, a thigh, a knee, a calf, an ankle, or a foot of the user.

17. A system for facilitating exercise by a user riding in a vehicle while seated in a seating area of the vehicle, the system incorporates one or more exercise apparatus each having at least one sensor and at least one interface component into the seating area of the vehicle, where the exercise apparatus are configured within at least one or more of the following components in a vehicle seating area: seat, dash, arm rests, door handles, steering wheel, floor, foot supports, console, ceilings, ceiling handles, safety belts or gear shifts.

18. The system of claim 17 where the exercise apparatus includes at least one sensor and an interface component.

19. The system of claim 18 where the interface component is comprised from at least part of the vehicle component and where the sensors are coupled to the interface component to record pressure applied to the interface component.

20. The system of claim 17 where exercise apparatus are incorporated into covers configured to cover at least one or more of the vehicle components.

21. The system of claim 18, where the at least one sensor comprises a sensor configured to measure force.

22. The system of claim 17, where at least one or the one or more exercise apparatus are configured to wirelessly couple to the one or more physical processors.

23. The system of claim 17 where the system includes one or more feedback components to provide one or more of visual feedback, auditory feedback, tactile feedback, or olfactory feedback.

24. The system of claim 23, where the one or more feedback components are disposed at the exercise apparatus and/or a mobile computing device in communication with the exercise apparatus.
